SEQUENCE LISTING (3 sequences)

SEQ ID NO: 1 - protein, 12 aa, synthetic construct
GPSVFPLAPSSK

SEQ ID NO: 2 - protein, 8 aa, synthetic construct
LLINVGSR

SEQ ID NO: 3 - protein, 9 aa, synthetic construct
LLIIGASTR

(19) United States
(12) Patent Application Publication
(10) Pub. No.: US 2026/0266697 A1
(43) Pub. Date: Sep. 10, 2026

(54) MICRO-SCAFFOLD AND METHOD USING THE SAME FOR TISSUE MAPPING

(71) Applicant: The Research Foundation for The State University of New York, Amherst, NY (US)

(72) Inventors: Jun QU, Amherst, NY (US); Ming ZHANG, East Amherst, NY (US); Min MA, Buffalo, NY (US)

(21) Appl. No.: 19/491,343

(22) PCT Filed: Jun. 7, 2024
(86) PCT No.: PCT/US2024/033163

§ 371 Date: Dec. 8, 2025

Related U.S. Application Data
(60) Provisional application No. 63/506,831, filed on Jun. 7, 2023.
(60) Provisional application No. 63/560,004, filed on Mar. 1, 2024.

(51) Int. Cl. G01N 1/06; B01L 3/00; B01L 9/00; G01N 1/28

(52) U.S. Cl. CPC G01N 1/06; B01L 3/50857; B01L 9/523; G01N 1/286; B01L 2200/146; B01L 2200/147; B01L 2300/0829; B01L 2300/18; B01L 2400/0478; G01N 2001/2873

(57) ABSTRACT

A tissue sample sectioning device including a supporting matrix having a top surface, configured to accept a tissue sample thereon, a micro-scaffold comprising a top, a bottom, and a plurality of micro-wells, wherein each micro-well is defined by at least one or more walls that extend between the top and the bottom of the micro-scaffold, and each of the one or more walls has a cutting edge at the bottom of the micro-scaffold, and a press configured to apply a force onto the micro-scaffold, such that when a force is applied, the cutting edge cuts the tissue sample, and the tissue sample is sectioned into the plurality of micro-wells. The disclosure also provides a method of sectioning a tissue sample using the supporting matrix and the micro-scaffold by applying a force.

### FIELD OF THE DISCLOSURE

The present disclosure relates to tissue-mapping, and in particular to precisely sectioning tissues for mapping purposes.

### BACKGROUND OF THE DISCLOSURE

Quantitative, proteome-level characterization of the often heterogeneous protein distributions on the whole-tissue level provides extensive insights into the spatially-organized regulatory processes/networks across all tissue regions, which is critical for a systemic understanding of biological functionality, disease mechanisms, and therapeutic effects. For example, heterogeneous distribution of protein drugs across tissues is frequently responsible for compromised efficacy and/or undesirable side effects in clinical practice. Characterization of the region-to-region variability in distribution of protein drugs as well as the drug targets and markers for efficacy/safety across the entire tissue, will afford highly valuable information to inform engineering and therapeutic efforts. However, spatially-resolved and accurate mapping of the proteome across a whole tissue represents a daunting challenge owing to the difficulties in sensitive and quantitative mapping of the numerous tissue proteins. For example, state-of-the-art immunoassay-based methods (e.g., multiplex-IHC) have generated exceptional tissue mapping datasets, while falling short in a relatively low number of targets per mapping analysis (<40) and often require extensive validation owing to concerns about antibody specificity and reproducibility.

Matrix-assisted laser desorption/ionization mass spectrometry imaging (MALDI-MSI) has been tremendously successful in measuring the distribution of small-molecule markers in tissues. However, mapping of proteins with MALDI-MSI, especially the low-abundance ones, remains exceedingly difficult. Recently, liquid chromatography-mass spectrometry (LC-MS)-based techniques have demonstrated exceptional sensitivity for protein analysis, which opens the possibility of spatially-resolved proteomics analysis by separating the tissue into micro-size, region-specific specimens, followed by LC-MS quantification. Towards this end, several works have been reported. A trailblazing study cut voxels from tissue slides with a steel blade device and analyzed ~1000 proteins with spatial information. Imperfections include low spatial resolution (1000×1000 μm) and difficulty in precise spatially-resolved micro-sampling.

Another strategy is laser-microdissection (LMD)-assisted NanoPOTS imaging, which was demonstrated in profiling the protein distribution across 24 micro-tissue areas. Most recently, a powerful Deep Visual Proteomics strategy, which utilizes an artificial-intelligence-driven LMD technique to procure spatially-specific samples at single-cell or even subcellular levels, was developed for spatial proteomics analysis.

These LMD-based methods have been successfully demonstrated in the survey of microscopic, focused tissue areas, but not feasible to measure protein maps on the whole-tissue level. The capacity of whole-tissue proteome mapping with deeper proteome coverage than the LMD-based methods would provide more extensive insights toward a deeper understanding of the region-specific biological regulations and drug effects, and is therefore highly complementary to the LMD-based methods.

However, such a method has not been developed, largely because of the absence of a robust and reliable micro-sampling method that enables uniform compartmentalization of a whole-tissue slice while precisely preserving the spatial information.

Thus, there is a need for quantitative, in-depth mapping of proteins on whole-tissue levels to provide comprehensive insights into the spatially-organized regulatory processes/networks related to diseases and therapy.

### BRIEF SUMMARY OF THE DISCLOSURE

To address this important need and to achieve sensitive, robust, and quantitative proteomics mapping covering all regions of a tissue slice, this disclosure provides a pipeline, micro-scaffold assisted spatial proteomics (MASP), capable of acquiring the distribution maps for thousands of proteins across a whole-tissue slice with high quantitative quality.

Further, the present disclosure provides a micro-scaffold assisted spatial proteomics (MASP) strategy, based on spatially-resolved micro-compartmentalization of tissue using a 3D-printed micro-scaffold, capable of mapping thousands of proteins across a whole-tissue slice with high quantitative accuracy/precision. The pipeline includes robust and complete tissue micro-compartmentalization with preserved spatial information, effective/reproducible procurement and preparation of the micro-specimens for sensitive LC-MS analysis and protein distribution map generation.

As shown in Example 1 of the present disclosure, the mapping accuracy was validated by comparing the MASP-generated maps of spiked-in peptides and brain-region-specific markers with known patterns, and by correlating the maps of the two protein components of the same heterodimer. The MASP was applied in mapping >5000 cerebral proteins in the mouse brain, encompassing numerous important brain markers, regulators, and transporters, where many of these proteins had not previously been mapped on the whole-tissue level.

An embodiment of the present disclosure provides a tissue sample sectioning device that may include a supporting matrix having a top surface, configured to accept a tissue sample thereon, a micro-scaffold having a top, a bottom, and a plurality of micro-wells, wherein each micro-well is defined by at least one or more walls that extend between the top and the bottom of the micro-scaffold, and each of the one or more walls has a cutting edge at the bottom of the micro-scaffold, and a press configured to apply a force onto the micro-scaffold, such that when the force is applied, the cutting edge cuts the tissue sample, and the tissue sample is sectioned into the plurality of micro-wells.

According to an embodiment of the present disclosure, the tissue sample sectioning device may further include an ejector configured to remove each sample of the tissue sample from the plurality of micro-wells.

According to an embodiment of the present disclosure, the press may be configured to apply a first force to the micro-scaffold, followed by a second force which is greater than the first force.

According to an embodiment of the present disclosure, the tissue sample sectioning device may further include a pressure sensor for measuring a force applied by the press.

According to an embodiment of the present disclosure, the press may further include a top portion and a bottom portion, wherein the top portion comprises at least one aperture and the bottom portion comprises at least one protrusion, wherein the at least one protrusion is configured to fit into the at least one aperture.

According to an embodiment of the present disclosure, the tissue sample sectioning device may further include a chamber configured to house the supporting matrix, the micro-scaffold, and the press.

According to an embodiment of the present disclosure, the chamber may be configured to regulate the temperature of the supporting matrix and the micro-scaffold.

According to an embodiment of the present disclosure, the chamber may further include a light, e.g., LED lights, a dry ice container, at least one fan, at least one humidifier, at least one temperature sensor, and/or at least one humidity sensor.

According to an embodiment of the present disclosure, the chamber may be made from a clear material, e.g., clear acrylic glass.

According to an embodiment of the present disclosure the dimensions of the micro-scaffold may be from 0.5 cm-20 cm×0.5 cm-20 cm.

According to an embodiment of the present disclosure, the micro-scaffold may be a resin material.

According to an embodiment of the present disclosure, the micro-scaffold may be made of HTM 140 V2 resin.

According to an embodiment of the present disclosure, the micro-scaffold may be a metal material.

According to an embodiment of the present disclosure, the micro-scaffold may include at least 50-40,000 micro-wells.

According to an embodiment of the present disclosure, the plurality of micro-wells may have a length and width of 50 μm-1,000 μm.

According to an embodiment of the present disclosure, the at least one or more walls of the plurality of micro-wells may have a thickness of 5 μm-200 μm.

According to an embodiment of the present disclosure, the plurality of micro-wells may have a quadrilateral shape.

According to an embodiment of the present disclosure, the micro-scaffold may contain 30×30 micro-wells.

According to an embodiment of the present disclosure the plurality of micro-wells may have a length of 50 μm-400 μm and a width of 50 μm-400 μm.

According to an embodiment of the present disclosure, the plurality of micro-wells have a hexagonal shape.

According to an embodiment of the present disclosure, the supporting matrix may be made of Polydimethylsiloxane (PDMS).

According to an embodiment of the present disclosure, the supporting matrix may have a quadrilateral shape.

According to an embodiment of the present disclosure, the dimensions of the supporting matrix may be 13 cm×13 cm×1 cm.

According to an embodiment of the present disclosure, the supporting matrix may have a thickness of 5 mm.

A further embodiment of the present disclosure provides a method of sectioning a tissue sample including placing a tissue sample onto a supporting matrix; placing a cutting edge of a micro-scaffold onto the tissue sample, wherein the micro-scaffold comprises a plurality of micro-wells; applying a force to the micro-scaffold, wherein the cutting edge of the micro-scaffold cuts into the tissue sample to section the tissue sample into the plurality of micro-wells; and collecting the tissue sample from the plurality of micro-wells.

According to an embodiment of the present disclosure, the method may further include transferring the tissue samples into test tubes.

According to an embodiment of the present disclosure, collecting the tissue sample from the plurality of micro-wells may include inserting a piston array into the plurality of micro-wells, wherein at least one piston of the piston array may be arranged to penetrate the tissue sample and to push the tissue sample out of the plurality of micro-wells.

According to an embodiment of the present disclosure, the at least one piston is scored at least a 1 mm distance from a bottom of the piston array to form a breakable tip.

According to an embodiment of the present disclosure, the at least one piston may be scored at 3.95 mm from the bottom of the piston array.

According to an embodiment of the present disclosure, the breakable tip of the at least one piston may be arranged to penetrate the tissue sample.

According to an embodiment of the present disclosure, the breakable tip may be clipped into test tubes.

According to an embodiment of the present disclosure, collecting the tissue sample from the plurality of micro-wells may include pushing the tissue samples out manually.

According to an embodiment of the present disclosure, collecting the tissue sample from the plurality of micro-wells may include pushing the tissue samples out manually with a pushing device.

According to an embodiment of the present disclosure, collecting the tissue sample from the plurality of micro-wells may include manually pushing out the tissue samples using a fused silica tube.

According to an embodiment of the present disclosure, the fused silica tube may have an outer dimension of 180 μm-500 μm.

According to an embodiment of the present invention, collecting the tissue samples from the plurality of micro-wells may include cutting the tissue samples with a laser beam. According to an embodiment of the present invention, the tissue samples may be pushed out with a laser beam.

According to an embodiment of the present disclosure, collecting the tissue sample from the plurality of micro-wells may include pushing the tissue samples out with a robotic device, a laser beam, an electrical device, a pneumatic device, and/or mechanical device or combinations thereof.

According to an embodiment of the present disclosure, collecting the tissue sample from the plurality of micro-wells may include pushing out the tissue samples with a needle configured to a robotic arm.

According to an embodiment of the present disclosure, the tissue sample may be a 1-2 mm thick slice.

According to an embodiment of the present disclosure, the force may be generated with a press.

According to an embodiment of the present disclosure, a first force may be applied to the micro-scaffold, followed by a second force which may be greater than the first force.

According to an embodiment of the present disclosure, the first force extended over an area of the micro-scaffold may be at or between 3-10 kg.

According to an embodiment of the present disclosure, the second force extended over an area of the micro-scaffold may be at or between 10-55 kg.

According to an embodiment of the present disclosure, the method may further include pre-cooling the supporting matrix to 0° C.-10° C.

According to an embodiment of the present disclosure, the method may further include pre-freezing the tissue sample to −10° C.-−5° C.

According to an embodiment of the present disclosure, the method may further include pre-cooling the micro-scaffold to 0° C.-10° C.

According to an embodiment of the present disclosure, the cutting edge of the micro-scaffold may cut into the tissue sample at 0° C.-10° C.

According to an embodiment of the present disclosure, the tissue sample may be collected from the micro-wells at 0° C.-10° C.

### DESCRIPTION OF THE DRAWINGS

For a fuller understanding of the nature and objects of the disclosure, reference should be made to the following detailed description taken in conjunction with the accompanying drawings.

FIG. 1 displays a schematic of an embodiment of the present disclosure to enable in-depth protein mapping across a whole tissue slice, as demonstrated in Example 1.

FIG. 2 displays a schematic of another embodiment of the present disclosure, as demonstrated in Example 1.

FIG. 3 displays the high reproducibility and accuracy of the presently disclosed techniques, as demonstrated in Example 1.

FIG. 4 displays spatial distribution maps of proteins acquired by an embodiment of the present disclosure, as demonstrated in Example 1.

FIG. 5 displays cerebral distribution maps of key proteins involved in the KEGG pathway of the dopaminergic synapse acquired by an embodiment of the present disclosure, as demonstrated in Example 1.

FIG. 6 displays cerebral distribution maps of key proteins involved in the KEGG pathway of Alzheimer's disease acquired by an embodiment of the present disclosure, as demonstrated in Example 1.

FIG. 7 displays maps of proteins involved in neurotransmitter transport and transporters expressed on the blood-brain barrier acquired by an embodiment of the present disclosure, as demonstrated in Example 1.

FIG. 8 displays an embodiment of the present disclosure.

FIG. 9 displays a tissue sample before and after micro-compartmentalization.

FIG. 10 displays an embodiment of the micro-scaffold wherein the micro-wells have a hexagonal shape.

FIG. 11 displays a tissue sample before and after micro-compartmentalization using the micro-scaffold with hexagonal shaped micro-wells, and the corresponding protein map.

FIG. 12 displays an embodiment of the present disclosure.

FIG. 13 displays the press prior to a force being applied and an embodiment of the present disclosure.

FIG. 14 displays the press after a force is applied and an embodiment of the present disclosure.

FIG. 15 displays an embodiment of the present disclosure using a pressure sensor, pressure sensor holder, and pressure monitor.

FIG. 16 displays the ejector in the form of a piston array.

FIG. 17 displays how the piston array is fit into the micro-scaffold.

FIG. 18 displays the piston array inserted into the micro-scaffold.

FIG. 19 displays dimensions of an embodiment of a piston within a piston array.

FIG. 20 displays an embodiment of the piston array being used to transfer tissue samples from the micro-scaffold into test tubes.

FIG. 21 displays an embodiment of the chamber.

FIG. 22. The main 3D printed devices involved in the spatially resolved micro-compartmentalization. (a) The photos of a 3D-printed micro-scaffold with sharp edges for precise and robust tissue compartmentalization. (b) The design and measurements (in mm) of the pressurization module, which enables uniform and well-controlled pressurization during the compartmentalization procedure. (c) The photo of the 3D-printed pressurization module.

FIG. 23. The rationale for that an optimal supporting matrix with proper elasticity and strength is important to enable complete tissue compartmentalization with segregated micro-specimens. (a) The initial pressure is applied to the assembled micro-scaffold (gray), tissue slice (yellow), and the supporting matrix (blue), which prevents tissue motion. (b) The supporting matrix protrudes into the micro-wells under the increased pressure, cutting off the tissue around the microwell. (c) The supporting matrix remains intact after the retraction of the micro-scaffold, while the micro-specimens were individually sequestered in each micro-well.

FIG. 24. The identified proteins in the tissue slices with or without pre-freezing. (Student t test, 2-sided, t=3.076, df=12, p=0.0096, *: p<0.05, **: p<0.01, N=7 per group). Data are presented as mean±SD. df, degree of freedom. W/0 pre-freezing: light gray. With pre-freezing: dark gray.

FIG. 25. The 30-printed piston arrays for efficient and reproducible recovery of micro-specimens. (a) The design and measurements (in mm) of a series of staggered piston arrays. each matching 1 out every 4 micro-wells in both horizontal and vertical directions; (b) The photos of the 3D-printed piston arrays and the scheme of the efficient procurement of micro-specimens. (I) The photo of a representative 3 D-printed piston array with breakable pistons. (2) The photo of the micro-scaffold and the inserted piston array with breakable pistons showed in the zoomed-in window. (3) The clip and transfer of the piston, which carries the micro-specimen. into sample tubes. (4) Using the set of 16 piston arrays, each with staggered positions, rapid collection of all micro-specimens in the micro-scaffold can be achieved within 1 hour.

FIG. 26. The procurement chamber with tightly regulated conditions for efficient and reproducible recovery of the micro-specimens. The chamber is equipped with all-angle LED lights to allow shadow-free operation, a controlled humidifier to provide the desired high humidity, and a dry ice container to provide low temperature and saturated CO₂ in the chamber.

FIG. 27. The optimization of some key parameters of the μ.-SEPOD protocol, which permits the reproducible and robust sample preparation across the large cohort of micro-specimens. (a) The protein yield (left) and quantified proteins (right) of micro-specimens extracted by 20 μL (pink), 30 μL (orange), or 50 μL (olive) surfactant cocktail buffer. One-way ANOVA test: F (DFn, DFd)=23.21 (2,6), p=0.0015, and Holm-Sidak's multiple comparisons test: 20 μL vs. 30 μL: p=0.0030, 20 μL vs. 50 μL: p=0.0030, 30 μL vs. 50 μL: p=0.8979. (*: p<0.05, **: p<0.01, NS: p 2:0.05, N=3 per group). Data are presented as mean±SD. (b) The protein concentration of micro-specimens without sonication (light purple) or with sonication by a water-bath sonicator (gray), or probe sonicator (dark purple). One-way ANOVA test: F (DFn, DFd)=9.947 (2,12), p=0.0028, and Holm-Sidak's multiple comparisons test: W/0 sonication vs. Bath sonication: p=0.0054, W/0 sonication vs. Probe sonication: p=0.0058, Bath sonication vs. Probe sonication: p=0.7966. (*: p<0.05, **: p<0.01, NS: p 2:0.05, N=5 per group). Data are presented as mean±SD. (c) The quantified proteins from the micro-specimens using standard (light plum) or low-protein-binding Eppendorftubes (dark plum). DFn, degrees of freedom in the numerator. DFd, degrees of freedom in the denominator.

FIG. 28. Schematic illustration of the data processing functions in MASP app. The MAsP app encompasses three primary functions: (1) generate customizable protein distribution maps based on the spatial coordinates and the protein abundances or z-scores, either for specific proteins or all proteins in the dataset; (2) analyze protein distribution patterns from the thousands of generated protein distribution maps to identify proteins with non-random, regional distribution patterns; discover protein maps with similar regional distribution patterns by the spectral clustering algorithm; (3) among all MASP-generated maps, identify correlated distribution patterns between protein maps, or find protein maps that have correlated distribution patterns with that of a protein of interest, based on either Pearson correlation coefficient or cosine similarity.

FIG. 29. The anatomical position of the brain slice used in this study. (a) The sagittal view of the brain slice which includes the main anatomical regions such as the cortex (Cx), hippocampus (Hip), thalamus (Th), and hypothalamus (Hypo). The 1-mm brain coronal slice was acquired at the anatomical coordinates of −1 mm to −2 mm posterior to bregma, denoted in the purple frame. (b) The coronal view of the brain slice, and the main anatomical regions. (c) the photo of a representative mouse brain coronal slice.

FIG. 30. Correlation between all sample preparation replicates (N=9) of QC samples, analyzed between every 20 micro-specimens runs.

FIG. 31. The designed locations and levels of the spiked-in non-endogenous peptides for the validation of the quantitative accuracy of MASP. The numbers denote the folds of spiked levels.

FIG. 32. Additional results for validation of the mapping reliability by MAPS. The maps of more region-enriched proteins that are highly expressed in certain brain regions, which correlated well with the literature. The z-score color scale is from 1.0 to 1.0.

FIG. 33. Cerebral distribution maps of the key proteins involved in synaptic pathways that are important for neurodegenerative diseases, cognitive function and aging. (a) Glutamatergic synapse pathway, (b) GABAergic synapse pathway, (c) Cholinergic synapse pathway, and (d) Serotonergic synapse pathway. The z-score color scale for (a)-(d) is from 1.0 (green) to 1.0 (red). The lime, blue, pink, and turquoise boxes on the KEGG pathway plots in (a), (b), (c), and (d), respectively, denote the proteins quantified by MASP.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, and process step changes may be made without departing from the scope of the disclosure.

Ranges of values are disclosed herein. The ranges set out a lower limit value and an upper limit value. Unless otherwise stated, the ranges include all values to the magnitude of the smallest value (either lower limit value or upper limit value) and ranges between the values of the stated range.

The steps of the method described in the various embodiments and examples disclosed herein are sufficient to carry out the methods of the present disclosure. Thus, in an embodiment, the method consists essentially of a combination of the steps of the methods disclosed herein. In another embodiment, the method consists of such steps.

The present disclosure provides a tissue sample sectioning device, and a method of sectioning a tissue sample for micro-scaffold assisted spatial proteomics (MASP). The device and method allow for accurate and quantitative protein mapping on the whole-tissue level.

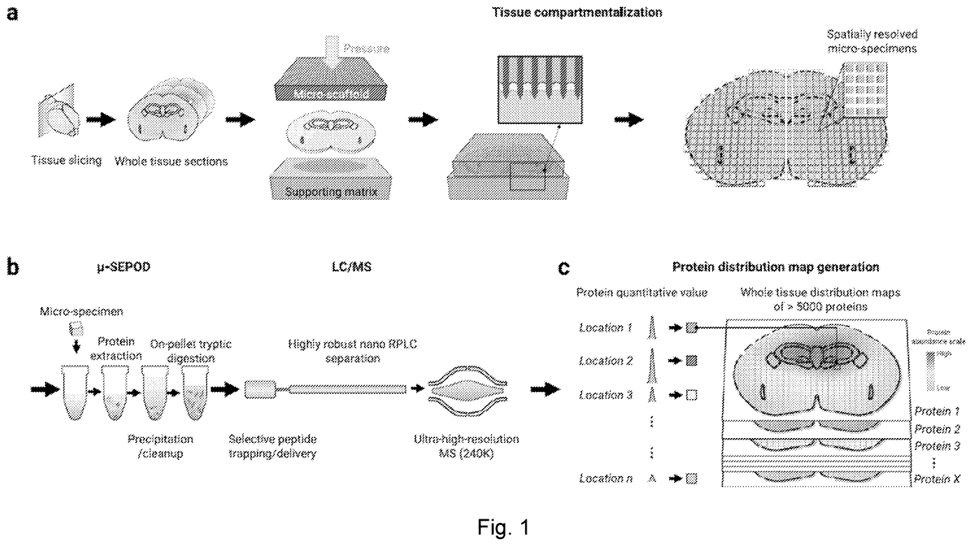

Robust and uniform micro-compartmentalization of a tissue slice while preserving the original spatial information is the very foundation for accurate mapping. The present disclosure provides a well-regulated pressurization, by applying a force, to a 3D-printed micro-scaffold, which contains numerous precisely-spaced micro-wells, against a tissue slice (FIG. 1A). Specifically, FIG. 1A displays the tissue sample sectioning device and the method of sectioning a tissue sample to enable accurate, quantitative, and in-depth protein mapping across a whole tissue slice.

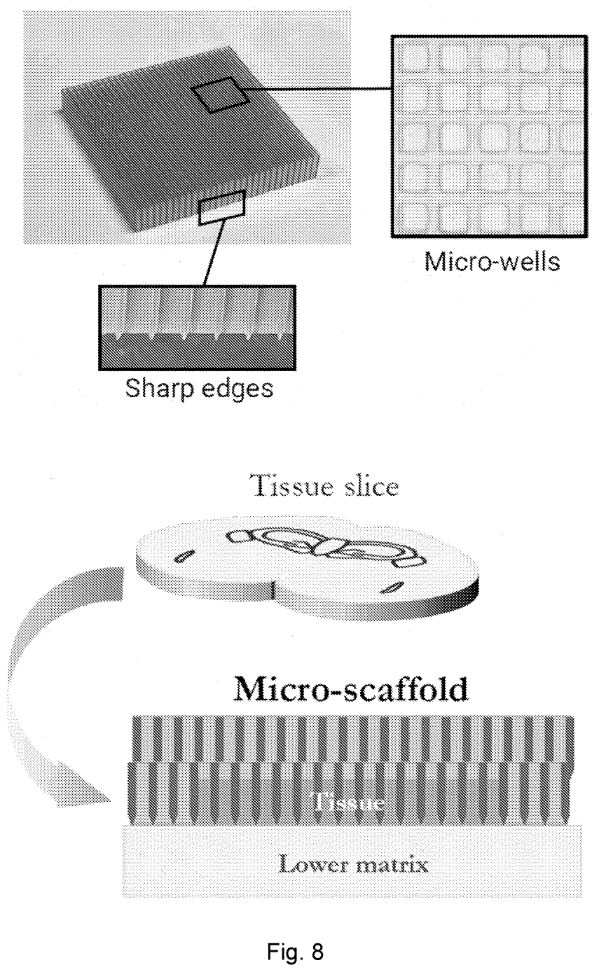

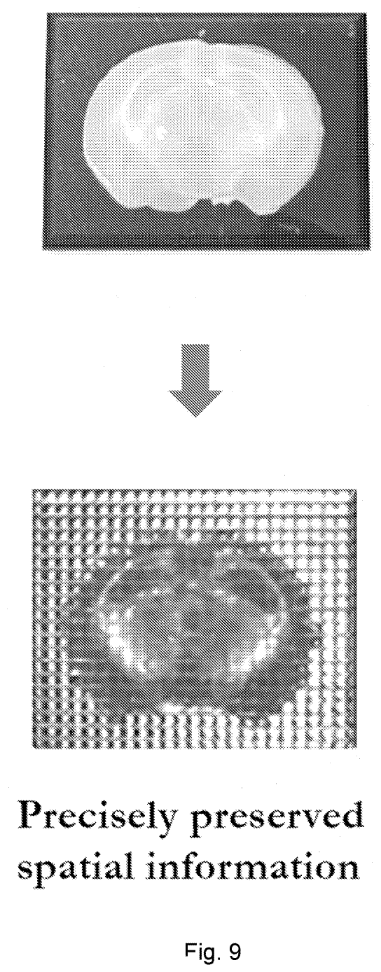

With reference to FIGS. 35 and 36 (also shown in FIGS. 1A and 8), the present disclosure may be embodied as a tissue sectioning device 10 which includes a supporting matrix 12 having a top surface 14, configured to accept a tissue sample 90 thereon; a micro-scaffold 20 having a top 21, a bottom 22, and a plurality of micro-wells 24, wherein each micro-well 24 is defined by at least one or more walls 25 that extend between the top 21 and the bottom 22 of the micro-scaffold 20, and each of the one or more walls 25 having a cutting edge 26 at the bottom 22 of the micro-scaffold 20. A press 30 is configured to apply a force onto the micro-scaffold 20, such that when a force is applied, the cutting edge 26 cuts the tissue sample 90, and the tissue sample is sectioned into the plurality of micro-wells. As shown in FIG. 9, the micro-compartmentalization precisely preserves spatial information of the tissue sample. The tissue sample may be a tissue slice that is 0.5-5 mm thick.

Further, with respect to FIG. 34 (also shown in FIGS. 1A, 13, and 14), the present disclosure provides a method 100 of sectioning a tissue sample including placing 103 a tissue sample onto a supporting matrix. A cutting edge of a micro-scaffold is placed 106 onto the tissue sample. A force is applied 109 to the micro-scaffold such that the cutting edge of the micro-scaffold cuts the tissue sample into a plurality of micro-sections, and each micro-section of the plurality of micro-sections is disposed in a corresponding micro-well of the plurality of micro-wells. The method includes collecting 112 the tissue sample from the plurality of micro-wells. In an embodiment of the present disclosure, the supporting matrix may be pre-cooled to 0° C.-10° C., prior to the tissue sample being placed onto it. Further, the tissue sample may be pre-froze to −10° C.-−5° C. The micro-scaffold may be pre-cooled to 0° C.-10° C., prior to applying the force to micro-compartmentalize the tissue slice.

In an embodiment of the present disclosure, the supporting matrix may be made of Polydimethylsiloxane (PDMS). The supporting matrix may be made of any material that will not break during micro-compartmentalization. The material should allow for a clean cut of the tissue sample. The supporting matrix may be a quadrilateral shape. However, the supporting matrix may be any shape that can accept a tissue sample thereon. In an embodiment, the dimensions of the supporting matrix may be 13 cm×13 cm×1 cm, though the dimensions will be dependent on the size of the tissue sample. The supporting matrix may have a thickness of 5 mm. The supporting matrix may have any thickness that will support micro-compartmentalization.

In an embodiment of the present disclosure, the micro-scaffold is made of a resin material, such as HTM 140 V2 resin. The material of the micro-scaffold should be stable, strong, and achieve a high resolution. The micro-scaffold may be 3D printed. The dimensions of the micro-scaffold will depend on the size of the tissue sample being sectioned. The micro-scaffold may have any dimensions optimal for tissue sectioning to produce high resolution. In an embodiment, the walls of the micro-scaffold may be 5 μm-200 μm thick, depending on the material of the micro-scaffold.

In an embodiment of the present disclosure, the micro-scaffold is made of a metal material. In other embodiments, the micro-scaffold may be made of a blade that may be separated by a glass spacer or a spacer of another material.

As shown in FIGS. 8 and 9, the micro-scaffold may include micro-wells with a quadrilateral shape. In an embodiment of the present disclosure, the micro-scaffold may include 30×30 micro-wells. The number of micro-wells is dependent on the size of the tissue sample, and may be configured to include any number of micro-wells. In an embodiment, the micro-wells may have a length and width of 100-400 μm. However, the present disclosure is not limited to these dimensions, and the micro-wells may have any dimensions optimal for tissue sectioning. Further, the micro-wells may have a thickness of 10 μm-100 μm.

Embodiments of the present disclosure may be used for cutting tissues that are tougher to section and/or cut, such as skin, portions of the lung, or blood vessels. In order to better cut through tough tissues, an embodiment of the present disclosure may include a micro-scaffold having a total of 10-100×10-100 parallel blades. Each of the parallel blades may be, for example, 5 μm-20 μm thick. In an embodiment, the parallel blades may be spaced by glass sides (though other spacers may be used instead of or in addition to glass slides). The glass sides may be 100 μm-400 μm thick. Further, in an embodiment, the blades may be held together by being inserted into a 3D-printed block with gridded grooves that may be, for example, 3 mm-10 mm deep and 5 μm-50 μm thick.

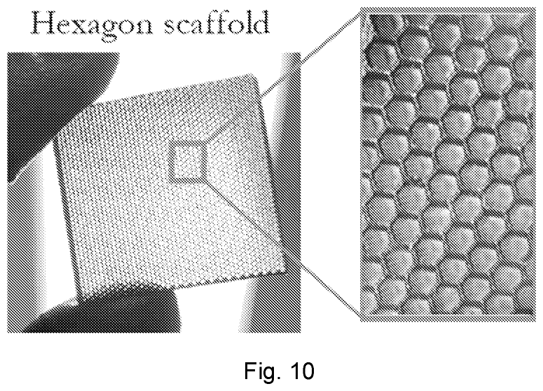

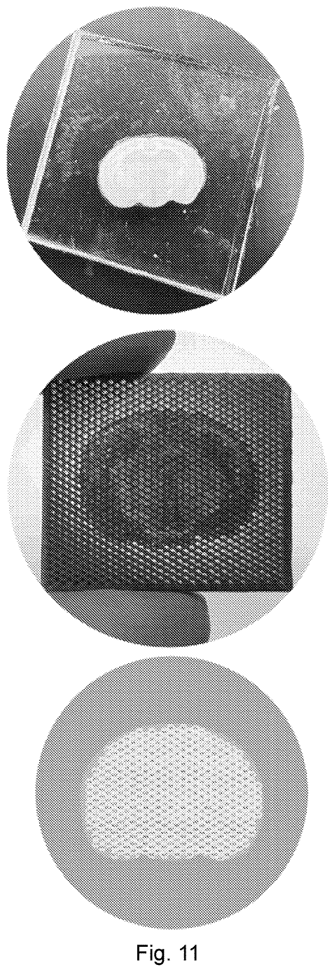

As shown in FIGS. 10 and 11, the micro-wells may have a hexagonal shape. The hexagonal shape allows for precisely preserved spatial information after micro-compartmentalization. Further, the hexagonal shapes allow for the complete micro-compartmentalization of the tissue sample, meaning no tissue sample is leftover following the cut.

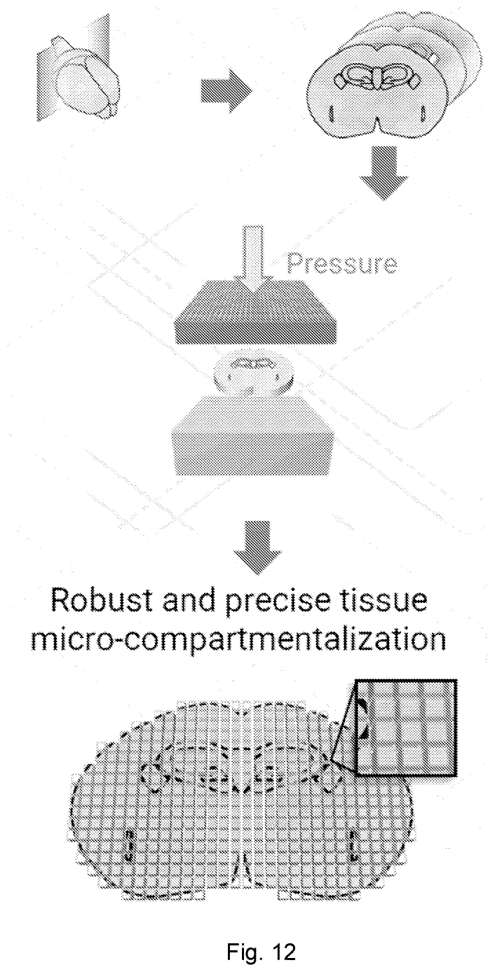

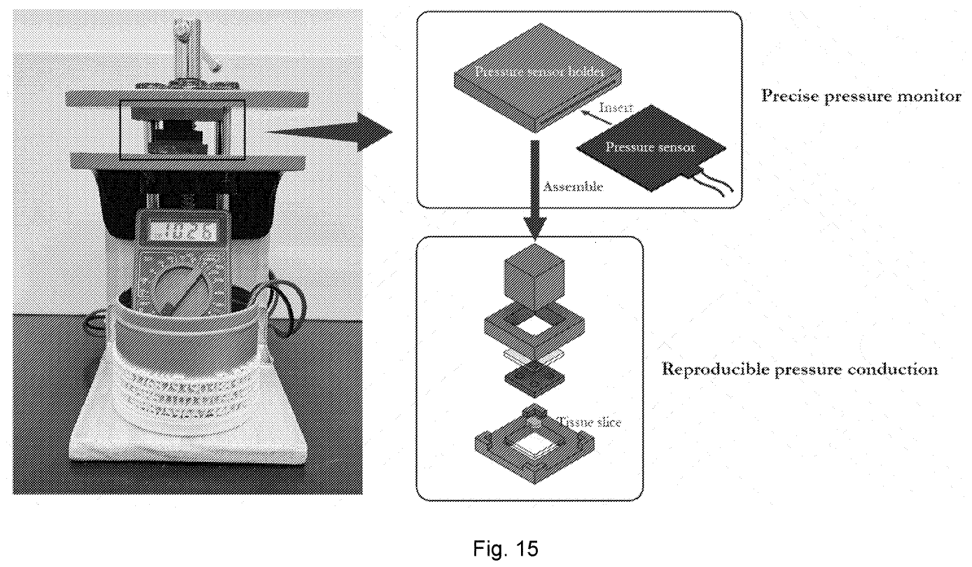

As shown in FIGS. 12-15, the press may be configured to apply a first force to the micro-scaffold to uniformly immobilize the tissue sample, followed by a second force which is greater than the first force, to cut through the tissue sample and compartmentalize the tissue sample into the individual micro-wells of the micro-scaffold. The first force extended over the area of the micro-scaffold may be at or between 3-5 kg. The second force extended over the area of the micro-scaffold may be at or between 10-15 kg. The tissue slice is completely micro-compartmentalized so that no remaining tissue is leftover following the cut and micro-compartmentalization. To measure the force applied to the micro-scaffold, the tissue sectioning device may further include a pressure sensor to measure the force exerted by the press. The pressure sensor may be configured inside of a pressure sensor holder. The pressure sensor may send a signal to a pressure monitor to showcase the magnitude of force exerted, which may be measured as a pressure.

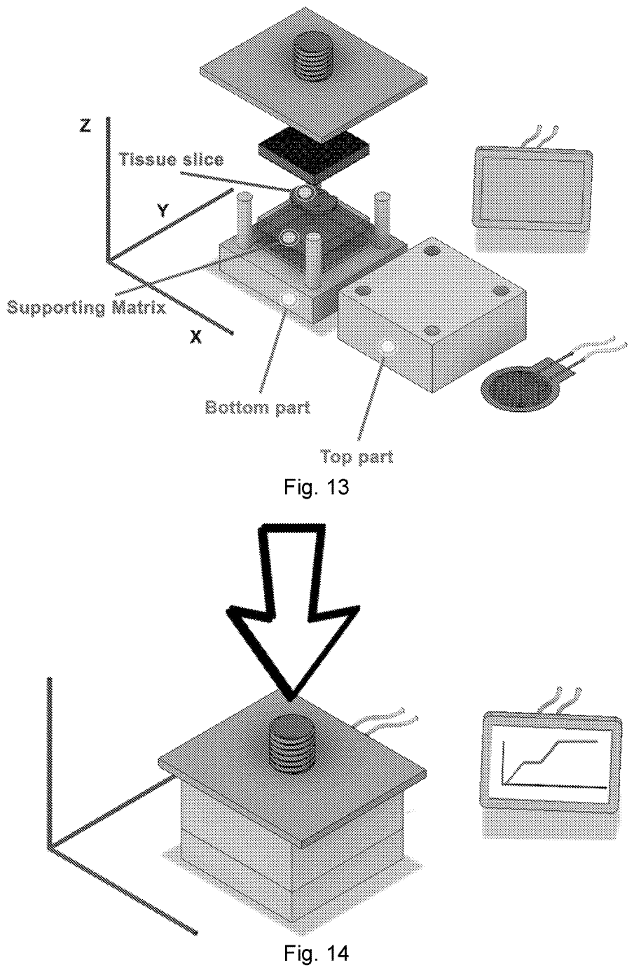

As shown in FIGS. 13-15, an embodiment of the press may include a top portion (part) and a bottom portion (part). The top portion may include at least one aperture and the bottom portion may include at least one protrusion. The at least one protrusion may be configured to fit into the at least one aperture when a force is applied to the top portion. In the embodiment shown, the supporting matrix, the tissue sample, the micro-scaffold, and the pressure sensor are arranged in between the top portion and the bottom portion.

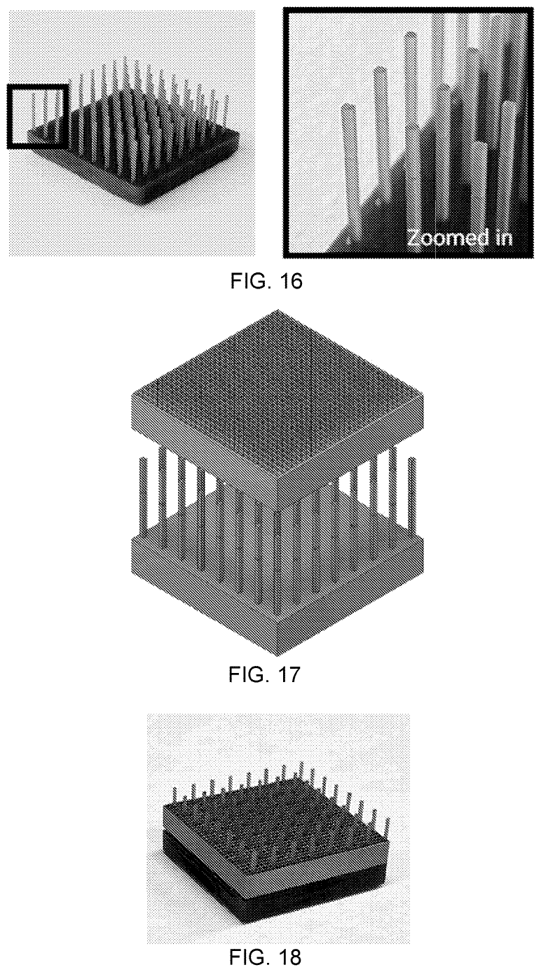

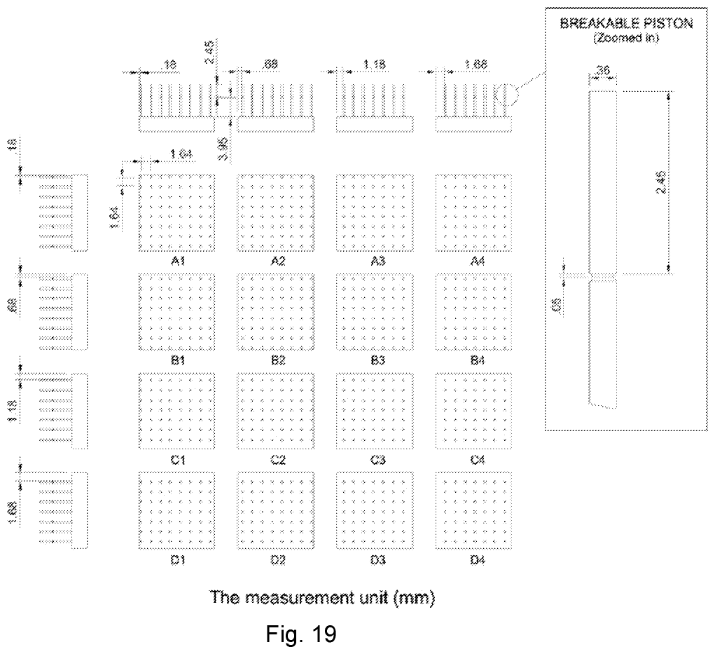

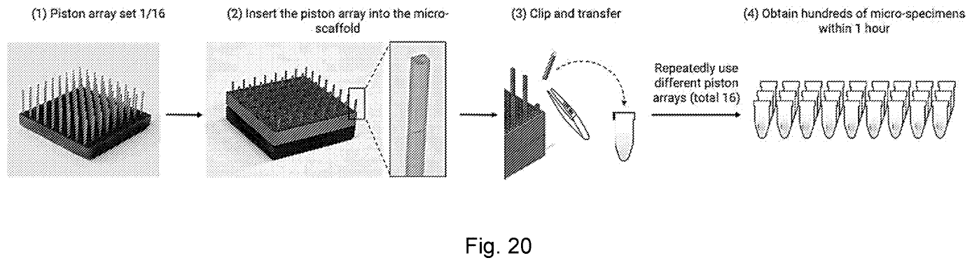

An embodiment of the present disclosure may further include an ejector that is configured to remove the compartmentalized tissue from the plurality of micro-wells. As shown in FIG. 16, the ejector may be a 3D-printed piston array. The piston array may be single use and configured for high-throughput transfer of compartmentalized tissue micro-specimens out of the micro-wells of the micro-scaffold. The piston array may be made of multiple pistons. As shown in FIGS. 17 and 18, the piston array may fit into the corresponding micro-scaffold by inserting the piston away into the micro-wells. When inserted, a breakable tip of the piston penetrates the tissue sample and pushes the sample out of the micro-wells. As shown in FIG. 19, the pistons may be scored at a distance from a bottom of the piston array to form a breakable tip. In an embodiment of the present disclosure, the piston may be scored at 3.95 mm from the bottom of the piston array. As shown in FIG. 20, the breakable tip may be clipped in order to transfer samples into test tubes for analysis.

Embodiments of the present disclosure may include other ejectors. For example, an embodiment of the ejector may include a fused silica tube with an outer dimension of 180 μm-500 μm. The fused silica tube may be used to manually push out the tissue. In an embodiment, the ejector may be a laser beam. The laser beam may be used to cut samples into a sample tube. In an embodiment, the ejector may be a robotic or mechanical component, such as a robotic arm. For example, the ejector may be a precisely controlled robotic arm with a needle or other end effector at the tip of the arm to push the tissue samples (eject) the samples form the micro-scaffold. Embodiments of the present disclosure allow for samples to be efficiently procured into a sample collecting device, such as a test tube. For example, 70% of sample masses could be procured into a test tube.

Embodiments of the present disclosure may include pipetting the compartmentalized tissue in a liquefied form from the plurality of micro-wells. In an embodiment, the compartmentalized tissue (micro-samples), may be digested in the micro-wells, for example, by adding extraction and digestion buffers into the micro-wells. By adding extraction and digestion buffers into the micro-wells, the proteins in the micro-samples can be extracted, denatured, and digested into proteolytic peptides. In an embodiment, the digested solutions may be pipetted out of the micro-wells (or removed from the micro-wells using other techniques, such as those suitable for liquids).

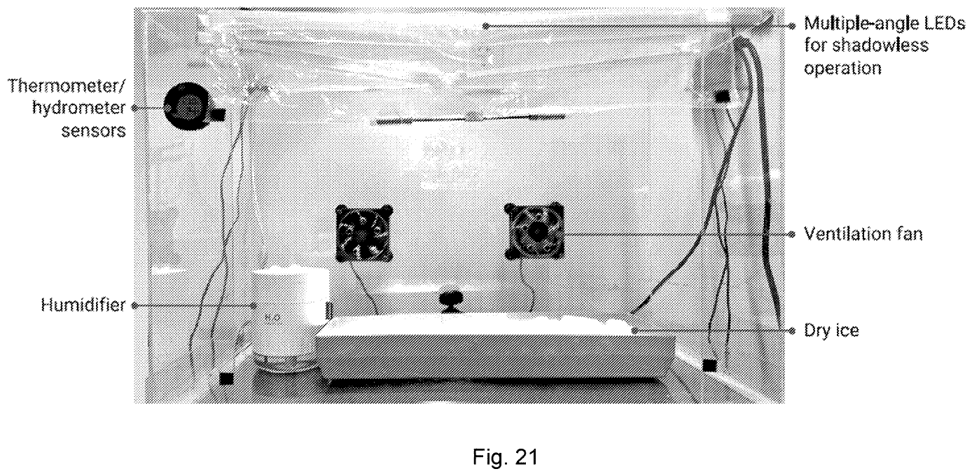

An embodiment of the present disclosure may further include a chamber configured to house the supporting matrix, the micro-scaffold, the press, and/or the ejector. As shown in FIG. 21, the chamber may include a light, e.g., LED lights, a dry ice container, at least one fan, at least one humidifier, at least one temperature sensor, and/or at least one humidity sensor. The chamber may regulate the temperature of the supporting matrix, the micro-scaffold, and the work-zone before, during, and after the micro-compartmentalization. The chamber may be made from a clear material, such as a clear acrylic glass. During micro-compartmentalization, the internal temperature of the chamber may be 0° C.-10° C. when the cutting edge of the micro-scaffold cuts into the tissue sample. Further, during collection, the internal temperature of the chamber may be 0° C.-10° C. when the tissue sample is collected from the micro-wells.

In an embodiment of the present disclosure, the methods disclosed herein may be automated. For example, a tissue sample sectioning device may include a processor in electronic communication with various components (e.g., press, ejector, etc.). The processor may be programmed to operate the components. For example, the processor may be configured to operate a press to apply force to a micro-scaffold in order to cut the sample. The processor may be programmed to operate an ejector to ejection the cut samples from micro-wells of the micro-scaffold. Other automation operations and/or components may be used to automate some or all of the presently-disclosed technique.

Although the present disclosure has been described with respect to one or more particular embodiments and/or examples, it will be understood that other embodiments and/or examples of the present disclosure may be made without departing from the scope of the present disclosure.

The following example is presented to illustrate the present disclosure. It is not intended to be limiting in any matter.

### Example 1

This example provides a description of in-depth mapping of protein localizations in whole tissue by the techniques disclosed herein, described in this example as micro-scaffold assisted spatial proteomics (MASP). This example utilizes the tissue sample sectioning device and the method of sectioning the tissue sample disclosed in the present application.

The MASP includes three components: first, robust and precise tissue micro-compartmentalization using a 3D-printed micro-scaffold; second, efficient and reproducible extraction, clean-up, and digestion of the location-specific micro-specimens followed by a sensitive/reproducible LC-MS analysis; third, generation of protein distribution maps with a MAsP app following accurate protein quantification.

Accurate, in-depth mapping of proteins on whole-tissue levels provides comprehensive insights into the spatially-organized regulatory processes/networks in tissues, but is challenging. This example describes a micro-scaffold assisted spatial proteomics (MASP) strategy based on spatially-resolved micro-compartmentalization of tissue using a 3D-printed micro-scaffold capable of mapping thousands of proteins across a whole-tissue slice with high quantitative accuracy/precision. The pipeline includes robust tissue micro-compartmentalization with preserved spatial information, reproducible procurement and preparation of the micro-specimens, followed by sensitive LC-MS analysis and map generation by a MAsP app.

The mapping accuracy of the embodiments disclosed in the present disclosure was validated by corroborating the i) spiked-in vs. observed patterns, ii) expected vs. observed maps of brain-region-specific markers, and iii) maps of protein components of the same heterodimer. The MASP was applied in mapping >5,000 cerebral proteins in mouse brain, encompassing numerous important brain markers, regulators, and transporters, where most of the proteins were first-ever mapped on the whole-tissue level.

Each of the components of the MASP was rigorously optimized to achieve accurate, quantitative protein mapping on the whole-tissue level. Firstly, robust and uniform micro-compartmentalization of a tissue slice while precisely preserving the original spatial information, is the very foundation for accurate mapping. In MASP, this was achieved by well-regulated pressurization of a 3D-printed micro-scaffold, which contains numerous spaced cubicles, against a tissue slice (FIG. 1A).

Specifically, FIG. 1A displays an embodiment of the present disclosure which enables accurate, quantitative, and in-depth protein mapping across a whole tissue slice. FIG. 1A displays robust tissue micro-compartmentalization with preserved spatial information using a 3D printed micro-scaffold. FIG. 1B displays the efficient and reproducible preparation of the location specific micro-specimens (micro-surfactant-aided extraction/precipitation/on-pellet digestion, μ-SEPOD) followed by robust/sensitive LC-MS analysis. FIG. 1C displays protein mapping by the MAsP app, which matches the accurately-measured protein abundance to the corresponding location of each micro-specimen. The app also generates customizable protein maps and offers various post-processing functions such as clustering or correlation of protein distribution patterns (more details are in the Supplemental Discussion (below)). The protein abundance scale is displayed in shades of gray as indicated.

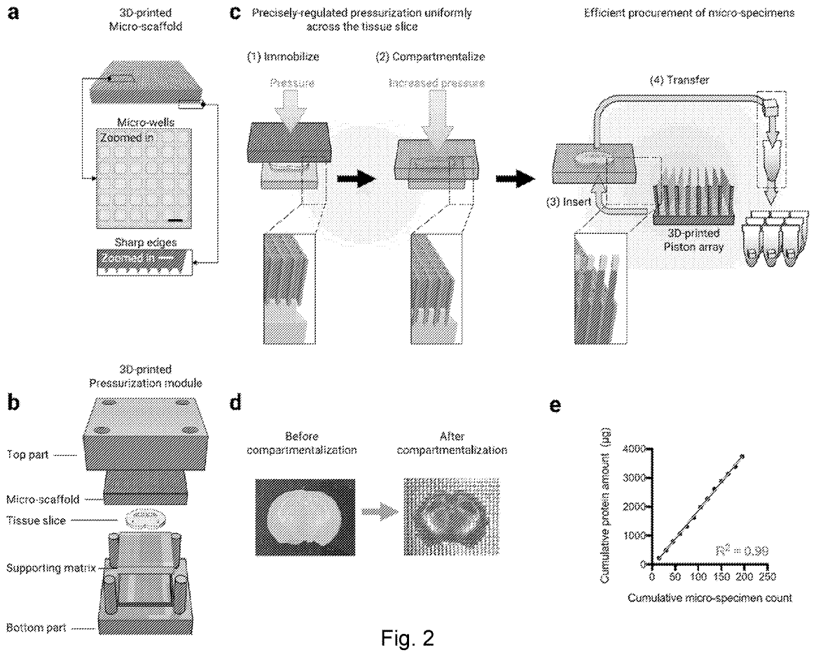

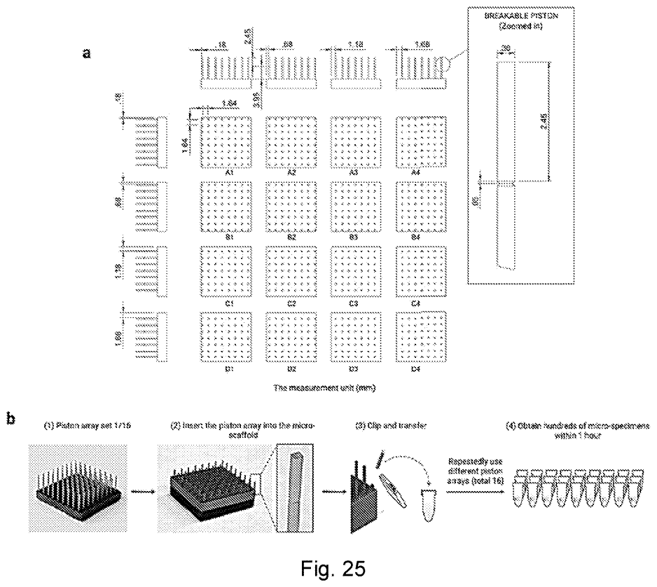

The rationale and workflow of precise micro-compartmentalization of the tissue and the procurement of spatially resolved micro-specimens utilizing the device and method disclosed herein is illustrated in FIG. 2. FIG. 2A displays a 3D-printed micro-scaffold with narrow edges to achieve precise tissue compartmentalization (scale bar: 400 μm). FIG. 2B displays the assembly of a 3D-printed pressurization module (the press) with the stack of micro-scaffold, tissue slice, and the supporting matrix (from upper to lower), to enable regulated and uniform pressurization across the entire tissue slice. FIG. 2C displays a schematic procedure for robust tissue micro-compartmentalization followed by efficient procurement of micro-specimens. A regulated pressure is applied on the micro-scaffold, which uniformly immobilizes (1) using a first force and then compartmentalizes the tissue slice with a second force (i.e., elevated pressure) (2). Next, a piston array with breakable pistons is inserted into the micro-scaffold to push the tissue specimens out of the micro-wells (3), detailed in FIG. 25. The micro-specimens are transferred to sample tubes (4)—e.g., each tissue specimen is transferred to a corresponding sample tube. FIG. 2D displays photos of a brain tissue slice before (left) and after (right) the compartmentalization. The entire tissue slice was uniformly and completely compartmentalized without any left-over tissue, while the spatial information was faithfully maintained. FIG. 2E displays exceptional linearity between cumulative protein amounts versus cumulative numbers of micro-specimens, indicating excellent reproducibility and robustness of both micro-compartmentalization and sample preparation, which sets a solid foundation for reliable protein mapping.

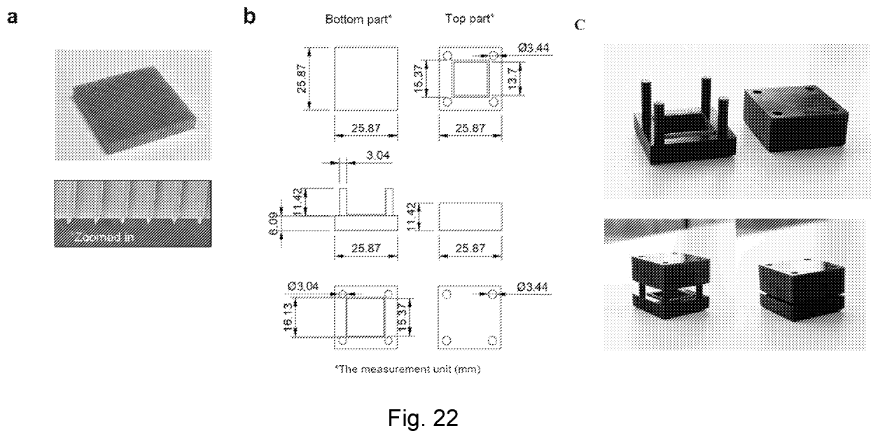

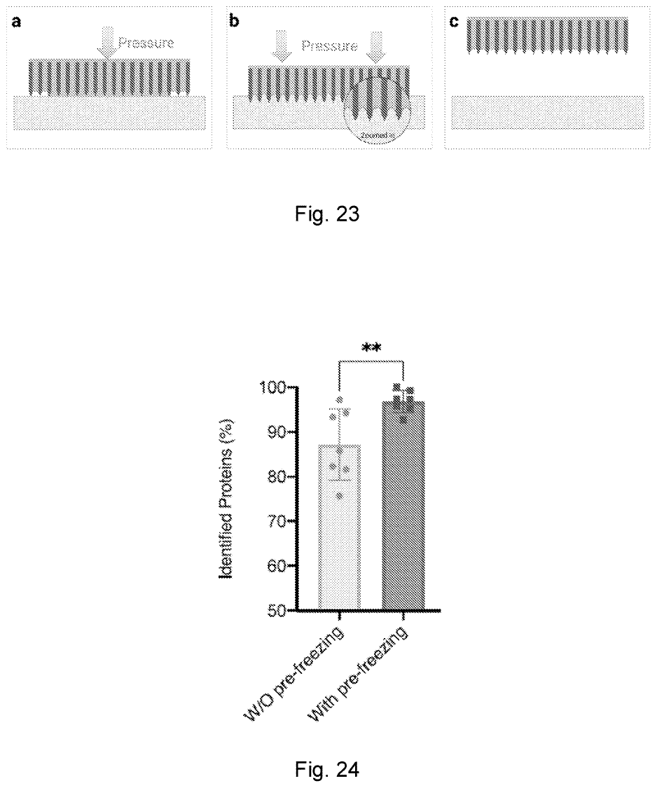

To avoid tissue distortion while attaining complete separation of individual micro-specimens, several measures were taken: (i) based on extensive evaluations on resolution, throughput, and properties of the materials, we chose to fabricate polymer-based micro-scaffolds. The example shown in FIG. 2A and FIG. 22a includes 900 spaced micro-wells with a 400 μm spatial resolution. When applying a force to the micro-scaffold against a tissue slice, the narrow edges of the micro-wells simultaneously immobilize all regions of a tissue slice to prevent tissue distortion, and then with increased pressure, cut through the tissue into a layer of supporting matrix (FIG. 2B, C) to allow robust tissue compartmentalization with completely separated micro-specimens; (ii) we found placing a layer of supporting matrix underneath the tissue during the pressurization step (FIG. 2B) was advantageous to achieve high-quality micro-compartmentalization. The supporting matrix material should have sufficient elasticity so that it can protrude into the micro-wells under pressurization to facilitate effective shearing of tissue against the narrow edges of the micro-scaffold, thus fully separating individual tissue specimens (FIG. 23). The material may advantageously also be sufficiently strong to sustain the high pressure that may be used for micro-compartmentalization. Additionally, the material may be rupture-resistant and introduce no contaminating proteins or detrimental polymers. After carefully assessing various candidates that are starch-, PVC- or silicon-based, we selected PDMS because it provides sufficient support for complete tissue compartmentalization without protein contaminations. Additionally, it was found that well-regulated pressurization uniformly across all the regions of the tissue slice is advantageous to attain robust and reproducible micro-compartmentalization. To achieve this goal, we devised a 3D-printed pressurization module, which encloses the stack made up of the micro-scaffold, a tissue slice, and the supporting matrix (in the upper-to-lower order, FIG. 2B, FIG. 22b, c). Force is applied at the top part of the module, to firstly immobilize (using a first force) and then completely compartmentalize the tissue slice (using a second force) (see, for example, FIG. 2C).

Under the optimized conditions (Supplemental Discussion (below), FIG. 24), the entire tissue slice was uniformly and completely compartmentalized without any left-over tissue, while the spatial information was faithfully maintained, as exemplified in FIG. 2D. To enable efficient, high-throughput transfer of micro-specimens out of the scaffold, we devised a series of 3D-printed piston arrays (a total of 16 arrays with staggered positions were designed to cover one micro-scaffold) with breakable pistons to rapidly procure the tissue micro-specimens (Supplemental Discussion (below), FIG. 25a). On each array, the pistons match one out of every adjacent four micro-wells in both horizontal and vertical directions. The pistons were scored and therefore breakable at the score line, so that the upper part of the pistons carrying micro-specimens can be easily clipped off and transferred into low protein-binding tubes for subsequent sample preparation (FIG. 2C, FIG. 25b).

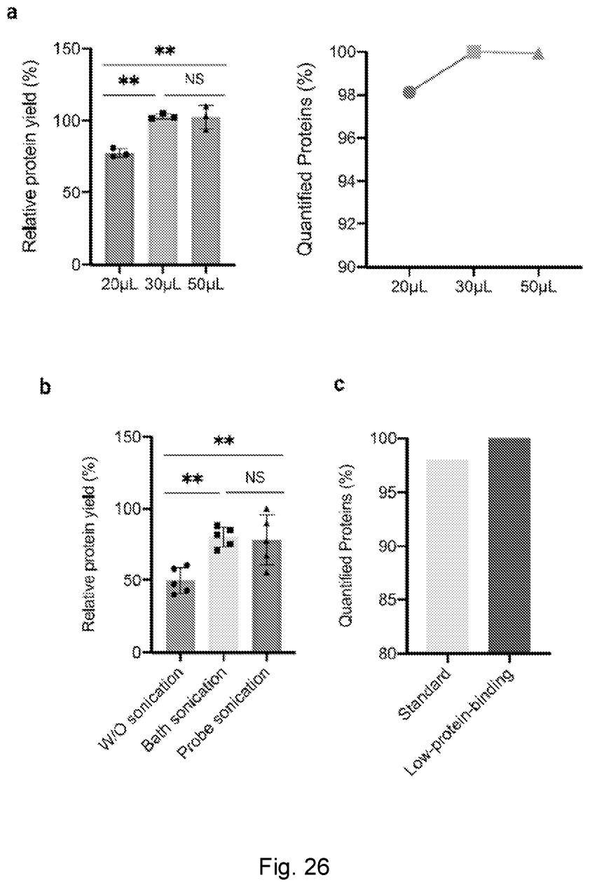

Finally, we found that ~70-80% humidity, −5 to 0° C. temperature, and free-of-oxygen are all beneficial to transfer the tissue micro-specimens. Therefore, the process may be performed in an enclosed chamber that regulates the above conditions. With the approach of the experimental embodiment, a 100% success rate in the procurement of high-quality micro-specimens from tissue slices was achieved, compared to ~52% when operated in the open air (Supplemental Discussion (below), FIG. 26).

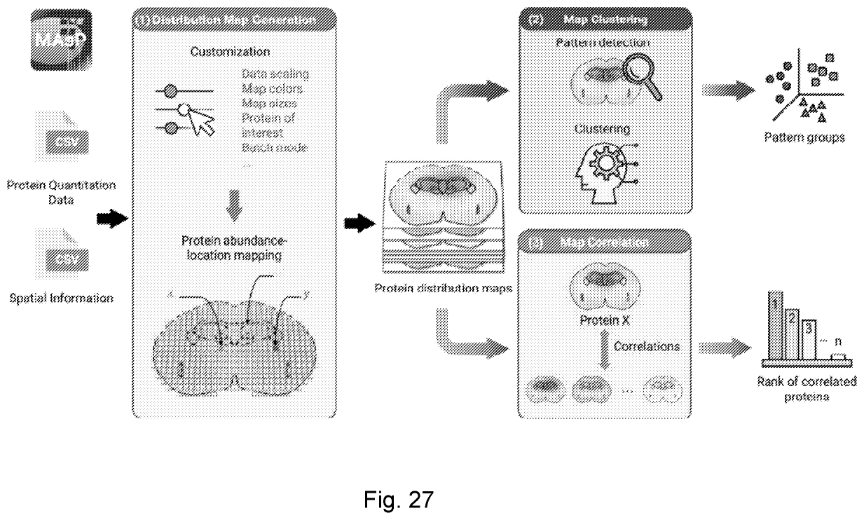

Secondly, efficient/reproducible sample preparation and LC-MS analysis, robustly across all micro-specimens, is another beneficial prerequisite for reliable mapping of tissue proteins. Previously, we described a SEPOD strategy, which employs a strong-detergent cocktail and provides near-complete tissue protein extraction, thorough cleanup of samples, and exceptional peptide recovery. Here, we modified and optimized the procedure to attain efficient preparation, reproducibly across all micro-specimens (termed μ-SEPOD, FIG. 1B). Details are in Supplemental Discussion (below) and FIG. 27. As exemplified in FIG. 2E, the cumulative recovered protein amounts versus the number of micro-specimens showed exceptional linearity (R2=0.99) across a tissue slice, indicating excellent reproducibility and robustness of both micro-compartmentalization and sample mapping. For LC-MS analysis, a trapping nano-flow LC system capable of extensive and robust analysis of large cohorts was employed. Moreover, the combination of ultra-high-resolution MS1 (240 K FWHM@m/z=200) and UHR-IonStar provides sensitive and accurate protein quantification, including the low-abundance ones (Supplemental Discussion (below)). All samples were prepared/analyzed in a random order to avoid analytical artifacts.

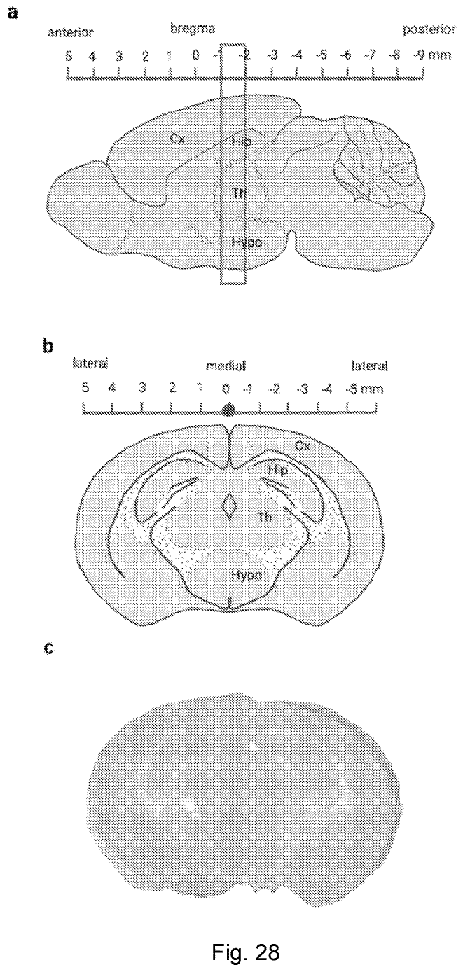

Thirdly, to generate and further analyze protein distribution maps in tissues, we developed an R-based spatial mapping app (MAsP, v 1.0, available at https://github.com/JunQu-Lab/MAsP FIG. 1C) with a graphical user interface (GUI). The module generates customizable protein maps and offers various post-processing functions such as clustering or correlation of protein distribution patterns (Supplemental Discussion (below), FIG. 28). The MAsP app constructs customized protein distribution maps based on the spatial coordinates and protein abundances of individual micro-specimens. The app also offers several functions for further analysis of the generated maps. For example, the “Map clustering” function was designed to group protein maps with similar distribution patterns, using a density-based clustering algorithm for image processing. Furthermore, the discovery of proteins with positively- or negatively-correlated distribution patterns provides valuable information on spatially organized biological processes. To identify these correlations, in MAsP, we also devised a “Map correlation” module to discover the proteins that have distribution maps correlating with the map of a protein of interest, based on either Pearson correlation coefficient or cosine similarity.

### Application of the MASP Strategy in the Mapping of the Cerebral Distribution of >5000 Proteins

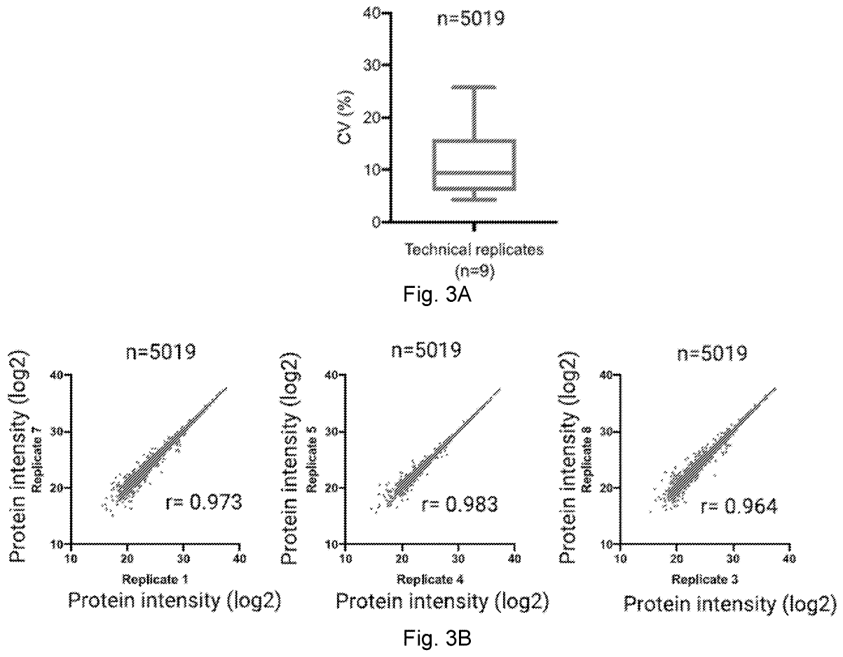

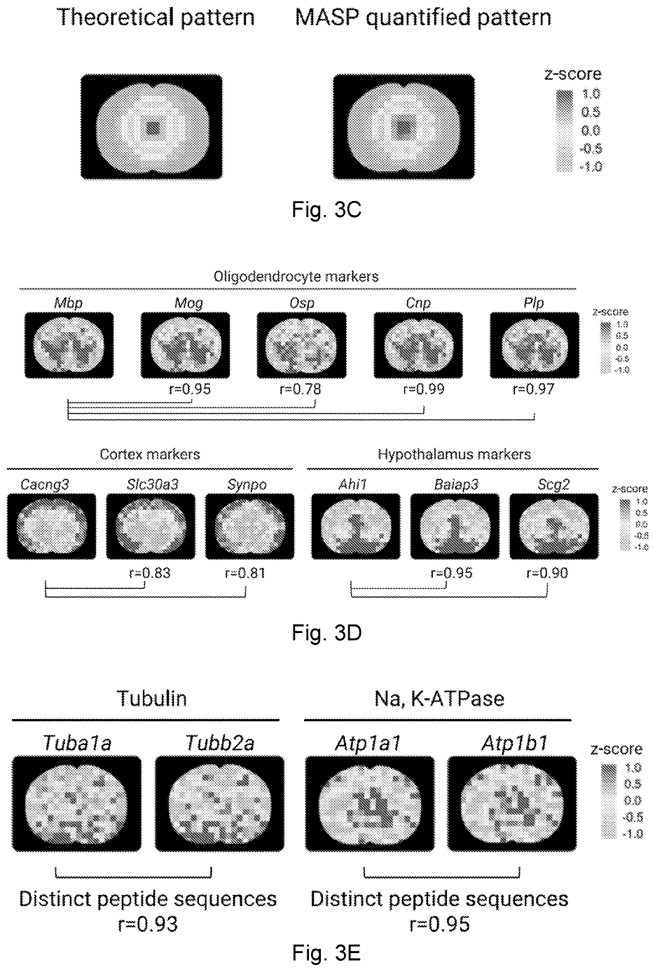

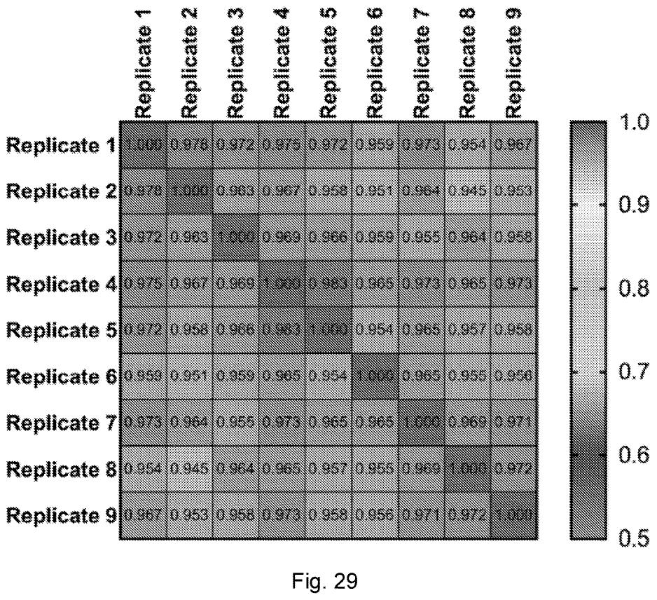

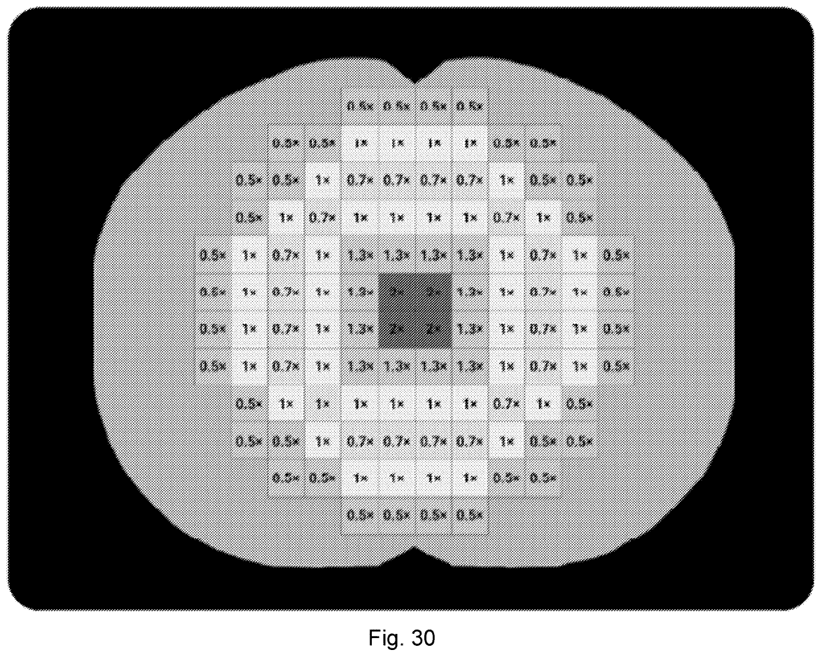

The MASP was applied to measure the whole-tissue distribution of the proteins in the brain of a healthy mouse. Under the stringent cutoff thresholds for identification and quantification (details in Methods), 5019 unique proteins were quantified and mapped in the brain slice (anatomical position is shown in FIG. 29). Complete distribution maps were obtained for 91.2% of these proteins (i.e., protein quantified in all locations of the brain slice, N=208 micro-specimens), and 98.2% of these proteins were mapped in at least 95% of all locations. To evaluate the quantitative quality, aliquots of 40 randomly-selected micro-specimens were pooled to create a QC sample, which was prepared and then analyzed between the analysis of every 20 micro-specimens. The quantitative method achieved low intra-group CV for protein abundance values (median CV=9.4%, N=9, FIG. 3A) and superb reproducibility for protein quantification (Pearson correlation r=0.964-0.983 between randomly-selected sample preparation replicates of QC samples, FIG. 3B). The correlations of all QC samples were shown in FIG. 30.

FIG. 3A displays intragroup CV % of the quantitative values of 5019 quantified proteins among sample preparation replicates of a pooled quality control (QC) sample (analyzed once every 20 micro-specimens, N=9). The box shows the 25th to 75th percentile range with the median indicated by a horizontal line. Whiskers extend to the 10th and 90th percentile range. FIG. 3B displays the correlation of quantitative values of 5019 quantified proteins between randomly-selected runs of the QC sample.

### Validation of the Mapping Accuracy of MASP

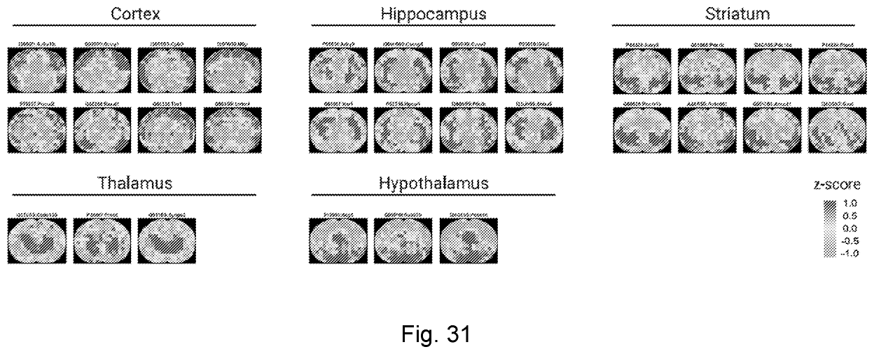

The mapping accuracy of MASP was validated in three ways. First, we spiked low, strategically-varied levels of non-endogenous, synthetic peptides into the micro-specimens collected at different locations (Supplemental Discussion (below), FIG. 31), so that a designed pattern would show up in the map of these peptides if the MASP achieved accurate mapping. We observed that MASP faithfully produced the expected patterns with excellent quantitative accuracy (mean quantitative error %=12.9%, FIG. 3C).

Second, we investigated the MASP-generated maps of the proteins with previously-known distribution patterns in the brain. Though for the vast majority of cerebral proteins, the whole-tissue level distributions remain unknown owing to technical limitations, the intra-brain distributions of a small number of markers have been reported, such as the markers of oligodendrocytes and a handful of brain-region-specific markers. It turned out that MASP correctly recapitulated the expected, region-specific distributions of these proteins, with excellent correlations among them. For example, the MASP-generated map of myelin basic protein (Mbp), a well-known oligodendrocyte marker, agreed well with its previously-reported distributions (FIG. 3D). We further compared the map of Mbp with four other oligodendrocyte markers: myelin oligodendrocyte glycoprotein (Mog), oligodendrocyte-specific protein (Osp), 2′,3′-cyclic-nucleotide 3′-phosphodiesterase (Cnp), and myelin proteolipid protein (Plp). As shown in FIG. 3D, the MASP-generated maps of these markers are consistent with the map of Mbp (Pearson correlation r values of 0.95, 0.78, 0.99, and 0.97, respectively). By comparison, the median r value for correlating Mbp with all other proteins was only 0.05; moreover, using a stringent Bonferroni correction method, it was found a Pearson correlation r>0.3 is significant (p<0.05). Therefore, the correlations of these maps are significant, suggesting reliable mapping by MASP.

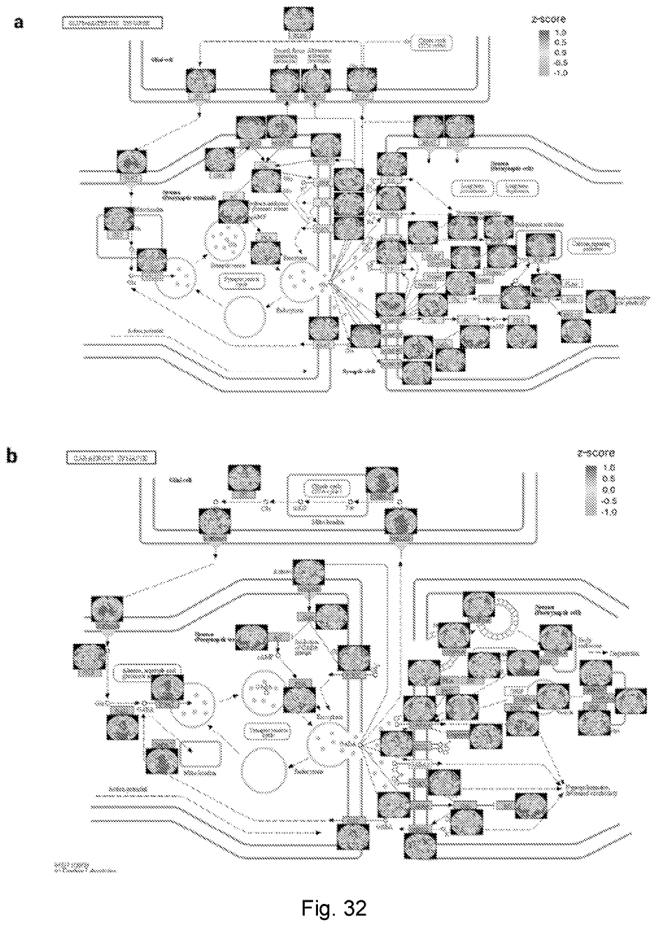

We also surveyed the maps of some protein markers that are known to be enriched in other brain anatomical regions. FIG. 3D showed that MASP correctly recapitulated the expected protein distributions in various anatomical regions such as the cortex (e.g., Cacng3, Slc30a3, Synpo) and hypothalamus (e.g., Ahi1, Baiap3, Scg2) with high correlations among the markers (Pearson's r=0.81-0.95). More examples of regionally enriched proteins are shown in FIG. 32, where the MASP-generated protein distribution maps exhibited patterns consistent with those reported in the literature.

Thirdly, we examined the mapping accuracy of MASP by correlating the spatial distributions of the two distinct proteins that form the same heterodimeric protein complex. If the MASP method was reliable, the maps of the two components of a heterodimer that were independently acquired by MASP, should show correlated distribution patterns. Here only the heterodimers that meet the following two criteria were chosen to validate the MASP technique: (i) the two proteins in the heterodimer must have distinct, non-overlapping sequences, because the shared peptides between the two proteins might lead to overestimation of mapping accuracy; and (ii) the two protein components should exist mainly in the heterodimer form so that most of these two proteins are co-located. For instance, in cells, tubulin-α (Tuba1a) and tubulin-β (Tubb2a), two proteins with distinct sequences, mostly exist in the form of a 1:1 heterodimer. Consequently, the spatial distributions of the tubulin α and β should be correlated if the mapping by MASP is accurate. Indeed, an excellent correlation (Pearson's r=0.93) between the maps of tubulin-α vs. tubulin-β was observed (FIG. 3E). Another example is that the individually-acquired maps of the heterodimeric sodium/potassium-ATPase α (Atp1a1) and β (Atp1b1) are highly correlated (Pearson's r=0.95, FIG. 3E).

FIG. 3C displays the agreement between the theoretical distribution and MASP-acquired map of strategically spiked non-endogenous peptides. FIG. 3D displays the maps of oligodendrocyte markers, Mbp, Mog, Osp, Cnp, and Plp, agreed well with the expected patterns and showed highly correlated distributions (Pearson correlation r=0.78-0.99) (upper); the distribution maps of proteins highly-expressed in the cortex or hypothalamus (lower). FIG. 3E displays the high correlation of the maps of the two distinct proteins that form the same heterodimeric protein complex, including the heterodimers of the tubulins and Na, K-ATPases. The z-score color scale for (c)-(e) is from −1.0 to 1.0.

### MASP Demonstrated the Potential to Produce a Valuable Resource of Whole-Tissue Protein Maps and Revealed Landscapes of Spatially Organized Signaling Pathways and Biological Functions

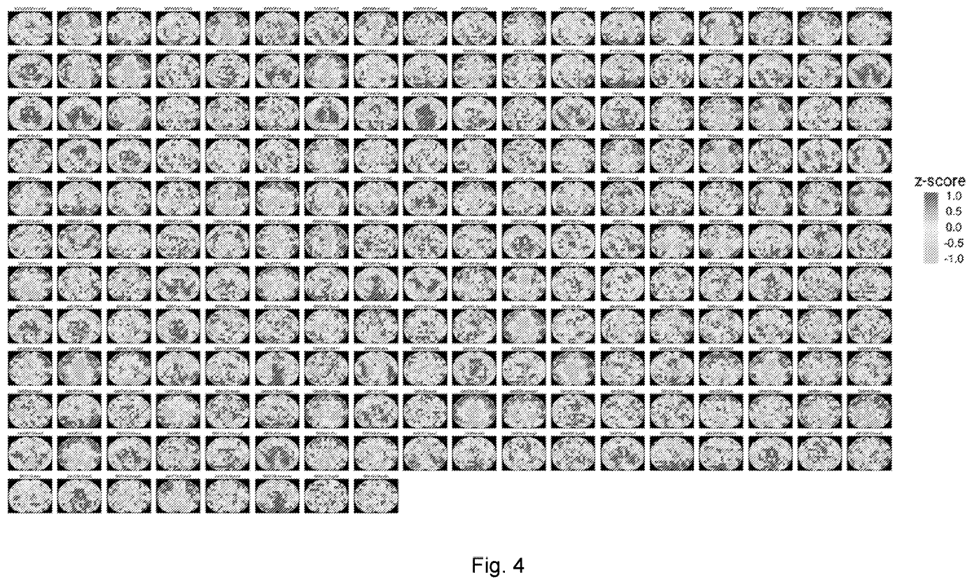

The >5000 cerebral protein maps by MASP, mapped on the whole tissue level, offered a unique resource comprising the intra-brain distribution maps for numerous proteins. The results revealed the considerable region-to-region variability for a large portion of brain proteins, which may extend our understanding of the spatially resolved biological functions of different brain regions. We have mapped numerous brain proteins, for example, ~94% and ~89% of all the proteins with the DAVID annotation of “hippocampus” and “brain cortex” were respectively mapped. For instance, the MASP-generated maps of the proteins that are involved in the brain developmental processes are shown in FIG. 4. FIG. 4 shows representative examples showing MASP's potential in providing insights into spatially organized biological processes. The spatial distribution maps of the proteins involved in developmental processes in the brain, including brain development (GO:0007420), synapse organization (GO:0050808), and axonogenesis (GO:0007409). The z-score color scale is from −1.0 to 1.0.

One unique advantage of MASP is that it generates whole-tissue protein distribution maps for many important players in various signaling networks and pathways, which affords the potential to provide a panoramic insight into the spatially organized biological functions. Here, as a few examples among many, we discuss the potential of MASP in the characterization of the spatially organized pathways involved in synapses and neurodegenerative diseases, and in the whole-tissue mapping of important neurotransmitters and drug transporters in the brain.

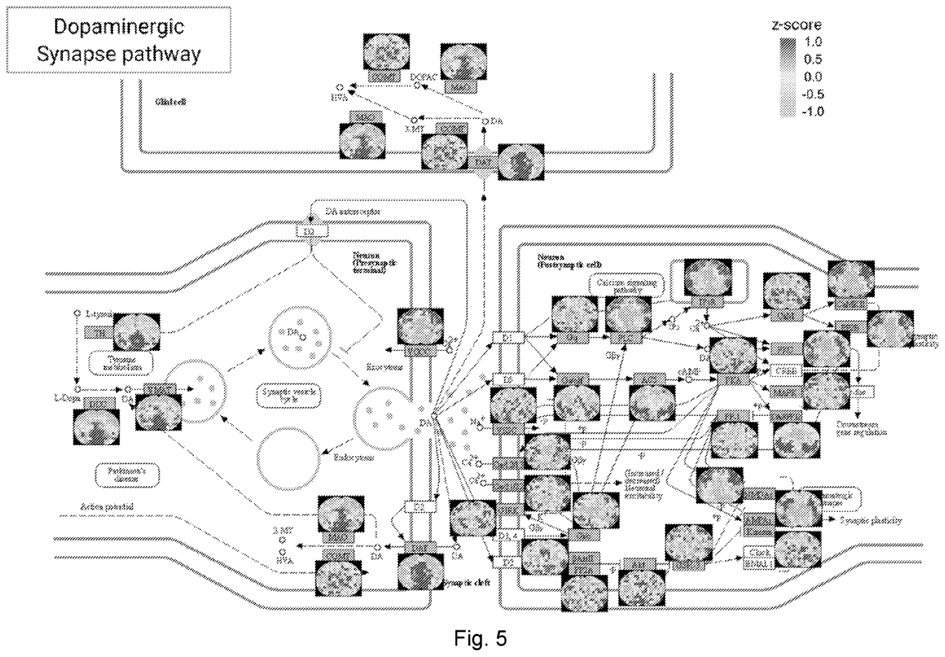

The first example includes the maps of proteins that are components of important synaptic pathways. Mapping the intra-brain distribution of the key components of synaptic pathways, which are implicated in a wide range of neurodegenerative diseases such as Alzheimer's disease (AD) and Parkinson's disease (PD) as well as cognitive function and aging, would provide valuable insights into the diseases and therapies. With MASP, we were able to achieve remarkable coverage in important synaptic pathways: ~76% protein components were mapped for glutamatergic synapse pathway, ~64% for dopaminergic synapse pathway, ~75% for GABAergic synapse pathway, ~57% for cholinergic synapse pathway, and ~43% for serotonergic synapse pathway. The mapped components in the dopaminergic synapse pathway, which are closely associated with the regulation of motor function in both PD and AD28, are shown in FIG. 5. Specifically, FIG. 5 displays cerebral distribution maps of key proteins involved in the KEGG pathway of the dopaminergic synapse acquired by MASP. The z-score color scale is from −1.0 to 1.0. The gray-shaded boxes on the KEGG pathway plots denote the proteins quantified by MASP.

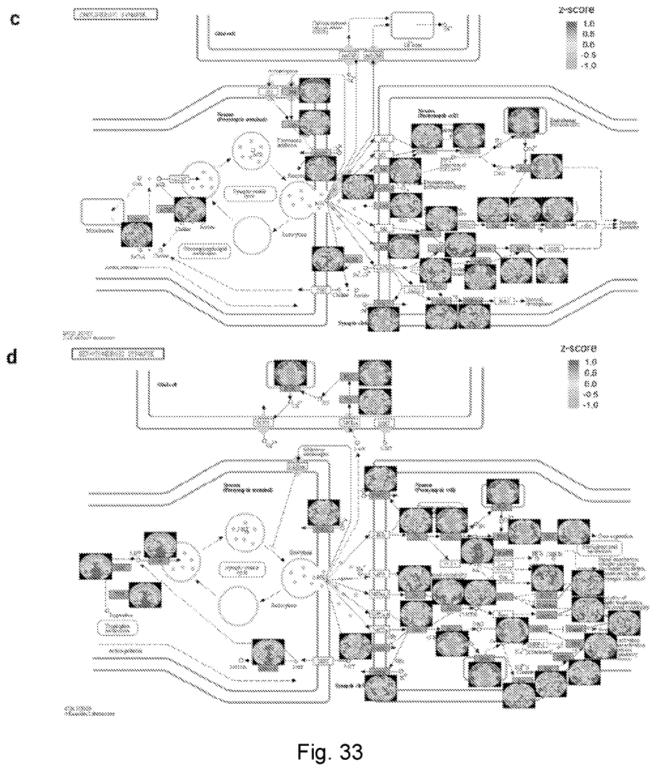

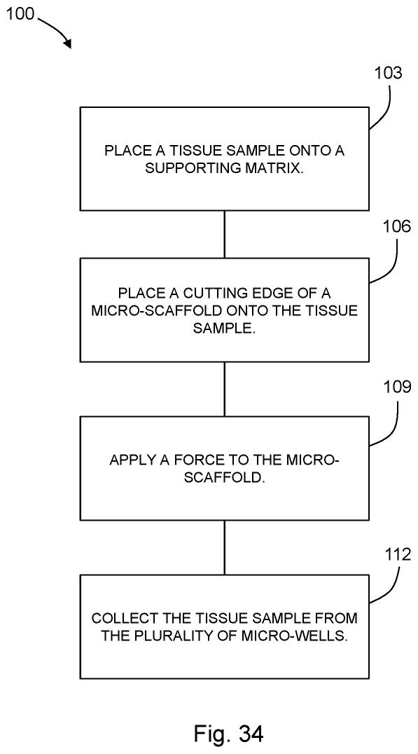

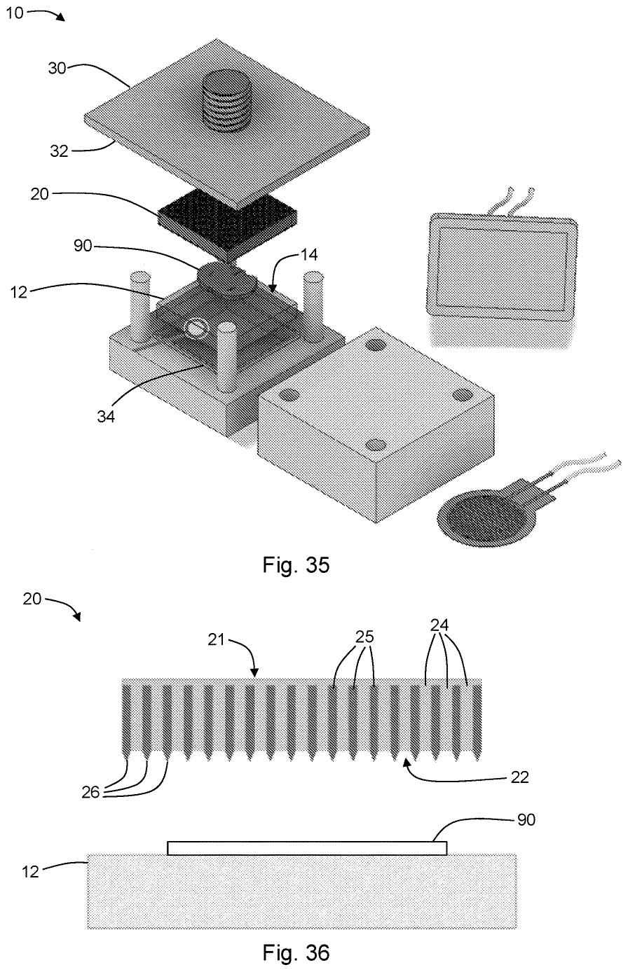

Glutamate is the most common neurotransmitter in the brain and glutamatergic neurons, which is important for multiple brain functions and synaptic plasticity. The maps of key players in the glutamatergic synapse pathway are shown in FIG. 33a. The maps of regulators in the GABAergic synapse pathway, cholinergic synapse pathway, and serotonergic synapse pathway are shown in FIG. 33b-d.

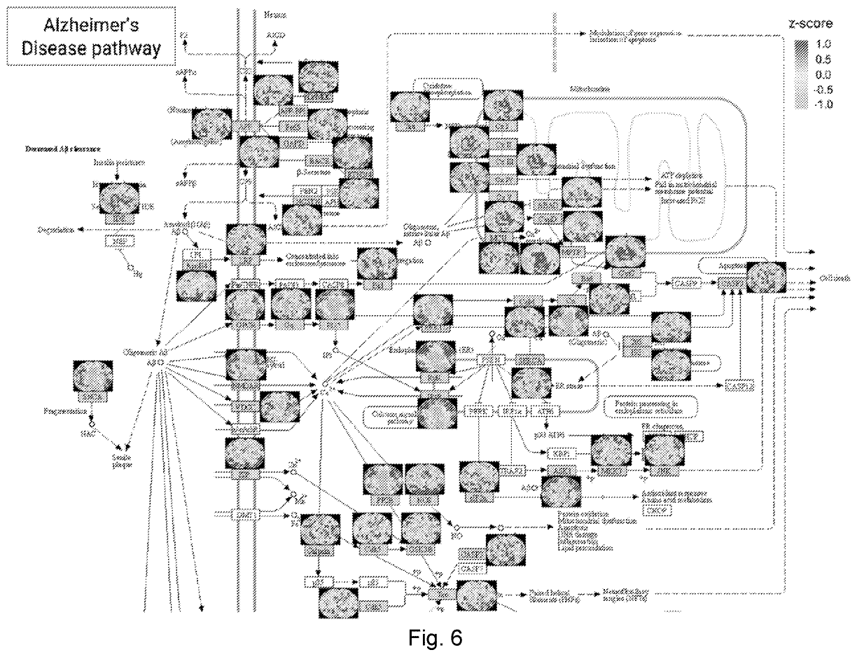

The second example involves important neurodegenerative disease pathways. The underlying molecular mechanisms of many neurodegenerative diseases such as AD, PD, Huntington's disease (HD) and prion diseases are poorly understood. Investigation of the cerebral distribution of the key proteins involved in these disease pathways can provide valuable insights that may facilitate the elucidation of the disease mechanisms. In this study, MASP was able to map most of the proteins in these pathways, providing an extensive view of the intra brain distribution of key players in these diseases. For example, MASP generated the maps for ~78% of the proteins involved in the PD pathway, ~71% of the proteins in HD pathway, ~61% of the proteins in the AD pathway (FIG. 6) and ~74% of proteins in the prion disease pathway. FIG. 6 displays cerebral distribution maps of key proteins involved in the KEGG pathway of Alzheimer's disease acquired by MASP. The z-score color scale is from −1.0 to 1.0. The gray-shaded boxes on the KEGG pathway plots denote the proteins quantified by MASP. Among these, important proteins that are known to aggregate in some neurodegenerative diseases were mapped in the brain, such as huntingtin (aggregation in HD), amyloid-beta in AD, alpha-synuclein in PD, and prion protein in prion diseases.

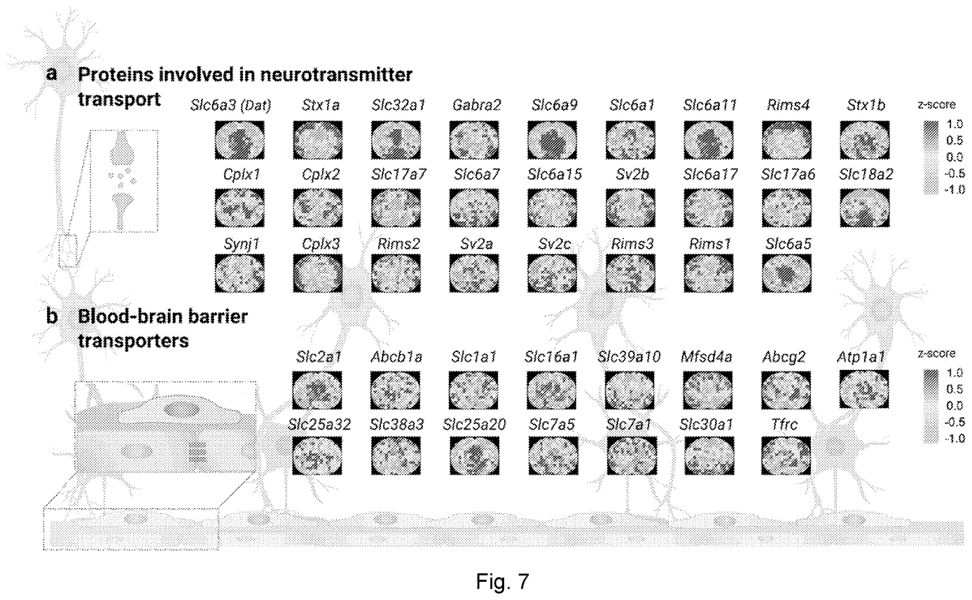

The third example encompasses the maps of proteins associated with neurotransmitter transport. Proteins involved in neurotransmitter transport mediate the uptake/efflux of neurotransmitters and thus shape the communication between the neurons. Because of their fundamental roles in maintaining the physiological functions of the brain, these proteins are often regarded as potential therapeutic targets for a spectrum of CNS disorders. Mapping the spatial distribution of the proteins involved in neurotransmitter transport could provide the landscape of region-specific neurotransmitter transporting activities and may facilitate the evaluation of potential drug targets. In this study, the MASP acquired cerebral distributions of 26 proteins involved in neurotransmitter transport (distribution maps are shown in FIG. 7A). FIG. 7A displays the spatial distribution maps of proteins involved in the neurotransmitter transport (GO:0006836).

The last example is the mapping of proteins associated with the blood-brain barrier (BBB). The BBB, which acts as a selective blood brain interface, has been of high interest in the study of brain functions, disease mechanisms and therapies. Particularly, as the BBB impedes the delivery of most drugs to the brain, the transporters carrying drugs or other important molecules across the BBB are highly critical for therapeutic efforts. Therefore, measuring the cerebral distributions of these transporters affords essential information for drug design and optimization of drug delivery. FIG. 7B showed the distribution maps of 15 representative transporters acquired by MASP, which encompass all known families of transporters across the BBB33, including ATP driven efflux pumps (Abcb1a, Abcg2, Atp1a1), carrier-mediated transport proteins (Slc1a1, Slc2a1, Slc16a1, Slc39a10, Slc25a32, Slc38a3, Slc25a20, Slc7a5, Slc7a1, Slc30a1), receptor-mediated transporter proteins (Tfrc), and the endothelial facilitator superfamily (Mfsd4a). FIG. 7B displays the spatial distribution maps of the important drug transporters expressed on the blood-brain barrier. The z-score color scale for a, b is from −1.0 to 1.0.

### DISCUSSION OF NON-LIMITING EXPERIMENTAL EMBODIMENTS

Using embodiments of the present disclosure (i.e., MASP), in-depth and accurate spatially resolved proteomic mapping on the whole-tissue level is achieved. This study generated a valuable dataset allowing the users to explore the cerebral distribution maps of >5000 unique proteins, which revealed the prevalent region-to-region heterogeneity in the distributions of proteins across the brain. Such resources will not only expand our knowledge of spatially resolved brain biology and functions, but also provides the basis to inform research concerning brain disease and therapy. The whole-tissue mapping capacity by MASP is complementary to the spatial proteomics strategies based on single-cell-proteomics or LMD, which enables comprehensive investigations of biologically and pharmaceutically meaningful region-to-region variations, as well as the integration of functional/pharmaceutical information with spatial information. Consequently, the method will markedly facilitate the efforts toward the understanding of the spatially organized biological regulations responsible for disease mechanisms and drug actions. For example, with MASP, one can investigate in what way a protein drug, its targets, and the efficacy/safety markers are spatially co-regulated in tissues, which could profoundly advance our understanding of how drug-induced biological cascades cooperate spatially to give rise to drug effects and side effects.

In MASP, the micro-compartmentalization and associated techniques are robust and versatile, which can be easily customized for different tissue types, and can be conjugated to any sample preparation, LC-MS, and protein quantification pipelines (e.g., multiplexed isotope-labeling, DIA, etc.), as long as an accurate, reproducible protein quantification across the micro-specimens is achieved. Future developments of MASP are ongoing in our labs, which include: (i) micro-scaffolds with higher spatial resolution, by taking advantage of the rapid advancements of the 3D-printing technologies; (ii) improvement of throughput on sample preparation and LC-MS analysis, e.g., automatic sample preparation with techniques such as SP3 magnetic beads and multiplexed analysis of micro-specimens with labeling techniques such as TMTpro; (iii) expand the applications of MASP beyond proteomics such as mapping of target markers of interest or post-translational modifications, and simultaneous investigation of spatially-resolved metabolomics and proteomics in the same set of micro-specimens, using a multi-omics analysis system we described previously.

### Materials and Reagents

Acetonitrile (ACN), Acetone, Formic Acid (FA), Methanol, Sodium dodecyl sulfate (SDS), and Sodium chloride (NaCl) were purchased from Fisher Scientific (MA, USA). Micro Bicinchoninic acid (BCA) protein assay was purchased from Thermo Fisher Scientific (CA, USA), Sodium deoxycholate, IGEPAL CA-630, Iodoacetamide (IAM), Trypsin (Proteomics grade), and cOmplete™ Mini EDTA-free Protease Inhibitor were acquired from Sigma-Aldrich (MO, USA). Dithiothreitol (DTT) was obtained from Cytiva (MA, USA). Tris was purchased from MP Biochemicals (OH, USA). Protein Lobind tubes (i.e., low-protein-binding tubes) were purchased from Eppendorf (Hamburg, Germany).

### Fabrication of 3D-Printed Devices for Micro-Scaffold-Assisted Tissue Compartmentalization and Procurement

All 3D-printed devices were designed using Autodesk Fusion 360 software (Autodesk Inc., USA). The micro-scaffold, pressurization module, and piston arrays were printed in-house by the Advanced-DLP technique (LED wavelength of 385 nm) using a D4Kpro 3D desktop printer (EnvisionTEC, Germany), with resolutions of 25 μm and 1 μm for the XY-axes and the Z-axis, respectively. The printer was calibrated following the manufacturer's protocol. The layer thickness was set to 25 μm and the printing build style was provided by the manufacturer and was specific to the printing material. We selected HTM140V2 (EnvisionTEC, Germany) resin owing to its high-resolution printing capability, excellent strength (Tensile Strength of 56 MPa), exceptional heat resistance (Heat Deflection Temperature up to 140° C.), and smooth surface finishing of the printed items. For curing, the micro-scaffold, pressurization module, and piston arrays were rinsed with 100% methanol, dried up by N₂ gas, then cured by ultraviolet (UV) at a wavelength of 405 nm for 4 minutes.

### 3D-Printed Micro-Scaffold

The micro-scaffold contained an array of precisely spaced micro-wells. In the example shown in FIG. 2A, a micro-scaffold containing 30×30 wells was fabricated. The dimension for each well was 400×400 μm. Each micro-well had narrower edges at the bottom (i.e., tapered), which was designed to effectively immobilize the tissue slice upon the initial contact and thereby faithfully preserve spatial information (FIG. 2A in the zoomed-in panel, FIG. 22a).

### 3D-Printed Pressurization Module (Press)

As shown in FIG. 2B, the pressurization module (press) included two parts that together enclosed the stack, which included the micro-scaffold, a slice of tissue, and a layer of supporting matrix. The regulated force was applied on the top part of the module, which transduces the force evenly to the micro-scaffold to achieve a uniform micro-compartmentalization. The module was carefully fabricated and tested to ensure sufficiently-precise fitting and leveling of these components. The design with the detailed parameters and the actual 3D-printed product is shown in FIG. 22b, c.

### 3D-Printed Piston Arrays for High-Throughput Transfer of Compartmentalized Tissue Micro-Specimens Out of the Micro-Scaffold

The design of a series of 3D-printed, single-use piston arrays, which fit the corresponding micro-scaffold shown in FIG. 2A, is exemplified in FIG. 25. When inserted into the micro-wells, the pistons push individual micro-specimens out of the micro-wells. The pistons were scored at 3.95 mm from the bottom to render them breakable so that the tips of the pistons carrying tissue specimens can be readily clipped into sample tubes, such as, for example, low-protein-binding tubes. To allow easy clipping, sixteen piston arrays with staggered piston positions were fabricated: on each array, there was one piston matching one out of every four micro-wells in both horizontal and vertical directions (FIG. 25). In this way, use of all sixteen piston arrays would address all of the micro-wells. Spacing apart the pistons of a particular piston array in this manner may allow more convenient processing of each micro-specimen.

### Polydimethylsiloxane (PDMS) Supporting Matrix

The polydimethylsiloxane (PDMS) supporting matrix was prepared using SYLGARD™ 184 Silicone Elastomer (DOW Inc, USA) according to the manufacturer's protocol (https://www.dow.com/en-us/pdp.sylgard-184-silicone-elastomer-kit.01064291z.html). Briefly, the mixture of Base Part A and Curing Agent Part B (10:1 v/v) was cured at 40° C. for 12 hours. The resulting PDMS block was cut into 1.3×1.3×1 cm sheets to serve as the supporting matrix during tissue compartmentalization (more details in Supplemental Discussion (below)).

Enclosing Chamber with Regulated Conditions to Enable Successful Procurement of Tissue Micro-Specimens

To achieve the desired conditions for the micro-sampling process, we devised an enclosed chamber using clear acrylic sheet glass which holds a 70 L volume (FIG. 26). The chamber was equipped with multiple LED lights to enable shadowless illumination of the operation areas, a dry ice container, temperature/humidity sensors as well as controlled ventilating fans, and a humidifier. The conditions for micro-compartmentalization and micro-specimen transferring were regulated as follows: −5 to 0° C., ~70-80% humidity, and the chamber is filled with CO₂ to displace air.

### The Tissue Sectioning, Micro-Compartmentalization, and Micro-Specimen Procurement

All animal experiments were performed according to the protocols approved by the Roswell Park Institutional Animal Care and Use Committee (IACUC). An eight-week-old male healthy Swiss Webster (CFW) mouse was anesthetized by isoflurane inhalation and then perfused with 15 mL heparinized saline. The mouse brain was harvested and rinsed with saline, and then sectioned into a series of 1-mm thick coronal slices using steel blades with an Adult Mouse Brain Slicer Matrix (BSMAS001-1, Zivic Instruments, USA). The slice at −1 mm to −2 mm from bregma was used for MASP mapping. The anatomical coordinates of the slice are shown in FIG. 29. The brain slice was mounted on the supporting matrix and then pre-froze at −80° C. for ~30 min before compartmentalization (FIG. 24).

The frozen slice was then compartmentalized into spatially resolved micro-specimens using the 3D-printed micro-scaffold, following these steps: first, the slice was mounted on a layer of PDMS supporting matrix which was securely settled into a holder on the bottom part of the pressurization module (press), followed by mounting a precooled (in −20° C.) micro-scaffold on the tissue slice with the sharp edge facing the tissue. The top part of the pressurization module (pre-cooled) was assembled to enclose the stack, and then pressure was applied to the top plate of the pressurization module via a steel press machine (VEVOR, USA) with a well-controlled force, and the force was monitored by a Fafeicy force-sensing resistor (Adafruit, USA) connected to a calibrated digital ohmmeter (Cen-Tech, USA). The initial force (~3-5 kg) was applied to immobilize the tissue, after holding for 10 seconds, the force was then increased to ~10-15 kg to finalize the micro-compartmentalization.

As described above, the micro-specimens were collected sequentially by the series of 16 piston arrays at −5 to 0° C., ~70-80% humidity, saturated CO₂ in the specimen-procurement chamber and then transferred into the low-protein-binding tubes that were pre-marked with the corresponding spatial coordinates.

### Microscale Surfactant Cocktail-Aided Extraction/Precipitation/On-Pellet Digestion (μ-SEPOD) for Preparation of the Micro-Specimens

In some embodiments, the sample preparation protocol was changed for the micro-specimens by modifying the Surfactant Cocktail-Aided Extraction/Precipitation/On-Pellet Digestion (SEPOD) protocol. All procedures were performed on ice unless indicated otherwise. For exhaustive protein extraction, 30 μL of surfactant cocktail buffer (50 mM Tris-FA pH=8.5, 150 mM NaCl, 0.5% sodium deoxycholate, 2% IGEPAL CA-630, 2% SDS, cOmplete™ Mini, EDTA-free Protease Inhibitor Tablets) was added into the tube of each tissue micro-specimen. The samples were sonicated in a water bath for 15 minutes at room temperature and then incubated at 4° C. overnight. The tissue lysates were vortexed and then centrifuged at 20,000 g (4° C., 30 minutes). The supernatant was carefully collected into the low-protein-binding tubes, and the remaining cell debris along with the snapped tip of the pistons was discarded. The total protein concentration of each sample was measured using the Micro BCA Protein Assay. For each micro-specimen, 10 μg of proteins were reduced by 10 mM DTT (56° C., 30 minutes), then alkylated by 25 mM IAM (37° C. for 30 minutes, in darkness) in a Thermomixer (Eppendorf, Germany) at 550 rpm. After adding 6× volumes of chilled acetone (−20° C.), the samples were placed at −20° C. for 3 hours for protein precipitation. Then, the samples were centrifuged using 20,000 g at 4° C. for 30 minutes, the supernatant was discarded, and the pelleted protein was carefully washed with 300 μL of methanol, then re-suspended into 28 μL of 50 mM Tris-FA (pH=8.5). Activated trypsin of 2 μL (0.25 μg/μL) was added at an enzyme-to-substrate ratio of 1:20 (w/w); and the tryptic digestion was performed in the Thermomixer at 37° C., 550 rpm for 6 hours. The digestion was terminated by adding FA to 1% (v/v) final concentration followed by centrifugation at 20,000 g, 4° C. for 30 minutes. The supernatant was transferred to autosampler vials for the LC-MS analysis.

In parallel, a quality control (QC) sample was prepared to monitor the technical variations. The QC sample contains 200 μg of total proteins that were pooled from 40 randomly selected micro-specimens. The QC sample was aliquoted and digested following the protocol described above.

### Liquid Chromatography-Mass Spectrometry

All spatially-specific micro-specimens were analyzed in a randomized order. The QC sample was injected in between every twenty runs, to monitor the analytical performance. A unique trapping-nano LC-high resolution MS system was used. The LC-MS system is made up of an UltiMate 3000 gradient Micro LC system, an UltiMate 3000 Nano LC system, a WPS-3000 autosampler, and an Orbitrap Fusion Lumos Tribrid Mass Spectrometer (Thermo Fisher Scientific, USA). The peptides derived from ~2.5 μg proteins were firstly delivered onto a trapping column (5×300 μm I.D.) at a flow rate of 10 μL/min with 1% B, to selectively remove the hydrophilic and hydrophobic matrix components. Then the peptides were loaded onto a nano-LC column (65 cm×75 μm I.D., 2.5 μm PepMap C18) and eluted at a flowrate of 250 nL/min using a gradient of 4% to 11% B for 5 minutes; 11% to 32% B for 117 minutes; 32% to 50% B for 10 minutes; 50% to 97% B for 1 minute, isocratic at 97% B for 17 minute. Mobile phases A and B for the nano-LC were 0.1% FA in 2% ACN, and 0.1% FA in 88% ACN.

The data was collected (Xcalibur v 4.2.47, Thermo Fisher Scientific, USA) at the positive mode using data-dependent acquisition (DDA) with a 3 second cycle time. The MS1 spectra were acquired in the m/z range of 400-1500, with a resolution of 240 K (FWHM@m/z=200). The maximum injection time for MS1 was 50 ms, automated gain control (AGC) target was 5E5. The dynamic exclusion was set to 60 seconds, and the mass tolerance was ±10 ppm. The precursor ions were filtered by quadruple with an isolation window of 1 Th and then fragmented by high energy collision dissociation (HCD) at a normalized collision energy of 30%. The MS/MS spectra were acquired under a resolution of 15 K (FWHM@m/z=200) using orbitrap. MS/MS maximum injection time was 22 ms, and the AGC target was 5E4.

### Generation of Protein Distribution Maps and Further Data Processing Using UHR-IonStar and the MAsP App

Protein identification and quantification were conducted using UHR-IonStar, a unique MS1-based quantitative proteomics pipeline, which achieves accurate and robust proteomic quantification in large cohorts, including low-abundance, regulatory proteins. UHR-IonStar measures peptide MS1 precursor ions with ultra-high-resolution (UHR, FWHM=240 k@m/z=200), and then precisely extract UHR-MS1 signals from the typically noisy backgrounds with extremely narrow, dynamically-defined m/z windows (e.g., 5 ppm) without losing signal intensity. This strategy effectively improves the selectivity and sensitivity for quantification of low-abundance proteins; along with an efficient chromatogram alignment approach, and a stringent post feature quality control method, the UHR-IonStar showed accurate, precise quantification of large cohorts with low missing data and low false-positives. Briefly, the LC-MS raw files were converted to mzXML format using Proteomics Tools and then the MS/MS spectra were searched against the Uniprot-SwissProt mouse database (16,961 entries, 2018) with the MS-GF+search engine (v 10089). A decoy database containing reverse sequences was concatenated to the forward database to allow the estimation of the false discovery rate (FDR) of the protein identification. The precursor ion mass tolerance was set to 20 ppm. The static modification was set to the carbamidomethylation of cysteine; the dynamic modification includes oxidation of methionine and acetylation of the N-terminal. Only fully tryptic peptides were considered. Each identified protein contains at least one unique peptide. The protein identification FDR was controlled on the entire dataset level at 1% using IDPicker (v 3.1.643.0). The quantitative feature annotation and further quantitative data processing were done by the UHR-IonStar package (v 1.5: https://github.com/JunQu-Lab/UHRIonStarApp). Briefly, MS1-peptide chromatographic peaks were aligned using the SIEVE (v 2.2.58) ChromAlign function to correct variations in chromatographic separation. The quantitative MS1 feature generation was conducted by a unique direct ion-current extraction (DICE) approach built in UHR-IonStar, which extracts the ultra-high-resolution MS1 peaks within defined, narrow m/z windows to enable sensitive and reliable quantification of all proteins including low-abundance proteins, as shown previously. The quantitative features were annotated with peptide IDs via a precise matching, and then quantitative values were aggregated from feature-level to peptide-level and then the protein-level.

To minimize the technical variations and achieve reproducible quantification, the total ion intensity (on the log 2 scale) in each sample was normalized using the Eq. (1):

$${P}_{i j} ( TICnormalized ) = {P}_{ij} - ( \frac{1}{m} {\sum }_{j = 1}^{m} {P}_{ij} - \frac{1}{mn} {\sum }_{i = 1}^{n} {\sum }_{j = 1}^{m} {P}_{ij} )$$

where Pᵢⱼ is the peptide abundance of j^{th} (j=1, 2, . . . , m) peptide in i^{th} (i=1, 2, . . . , n) sample after binary logarithmic transformation. For quantitative map generation, we further normalized the protein abundances against the abundances of these proteins quantified in the pooled reference samples (i.e., the QC samples) analyzed at the same time period as the micro-specimens. The users also have the option to use z-scores for map generation with the MAsP app, which allows a fair comparison/display of the spatial distribution of multiple proteins in the tissue slice.

The graphical user interface (GUI)-based MAsP app was developed to generate protein distribution maps as well as to perform further analysis of the maps. The app encompasses three primary functions (FIG. 28): (1) generate customizable protein distribution maps based on the spatial coordinates and the protein abundances or z-scores, for specific proteins or all proteins in the dataset; (2) analyze protein distribution patterns from the thousands of generated protein distribution maps to identify proteins with nonrandom, regional distribution patterns using a previously-published approach; discover protein maps with similar regional distribution patterns by the spectral clustering algorithm; (3) among all MASP generated maps, identify correlated distribution patterns between protein maps, or find protein maps that have correlated distribution patterns with that of a protein of interest, based on either Pearson correlation coefficient or cosine similarity. A manual with detailed information on the MASP app can be found at https://github.com/JunQu-Lab/MAsP.

### Validation of the Accuracy of the Mapping Technology

Three different approaches were used to validate the MASP pipeline. To examine the quantitative accuracy of the mapping strategy, nonendogenous peptides were spiked into the samples at specific locations to form a specific distribution pattern as shown in FIG. 3C. Three non-endogenous peptides (GPSVFPLAPSSK, LLINVGSR, LLIIGASTR) were spiked into the micro-specimens obtained from the designated location, at five different levels (0.5-, 0.7-, 1-, 1.3- and 2-fold at low fmol levels, respectively). These levels were designed to examine the ability of the method to discover relatively subtle differences among locations. The sequences of the peptides were concatenated into an artificial protein entry and added to the mouse Uniprot Swiss-Prot database. Based on the quantified protein abundance values, a distribution map of these peptides was then constructed and compared with the theoretical map based on the spiked-in ratios across the locations (FIG. 3C and FIG. 31).

To corroborate the cerebral distribution of certain proteins with literature-reported patterns, a list of region-enriched proteins was identified from the previous proteomic studies. The region-enriched expression patterns of these proteins were confirmed in the MASP generated distribution maps. The functional annotation and pathway analysis of the quantified proteins were performed using the DAVID Functional Annotation (v 6.8)39 and KEGG Pathways (v 101.0)40. The distribution map of the first matched protein was shown in the figure when multiple corresponding genes are listed under one protein in the KEGG pathway map.

Additional examples are presented in the following non-limiting Supplemental Discussion.

### SUPPLEMENTAL DISCUSSION

In-depth Mapping of Protein Localizations in Whole Tissue by Micro-scaffold Assisted Spatial Proteomics (MASP)

### Development and Optimization of the MASP Strategy

Robust and Uniform Micro-Compartmentalization of Tissue Slice while Precisely Preserving Spatial Information, a Critical Step to Achieve Accurate Protein Mapping on the Whole-Tissue Level

### The Development of a 3D-Printed Micro-Scaffold for Precise and Robust Tissue Compartmentalization

To achieve an accurate spatial mapping of proteins across the entire tissue slice, it is critical to precisely preserve the original spatial information when procuring the spatially specific micro-specimens. Moreover, the strategy should reproducibly recover micro-specimens of a uniform size, with high throughput and minimal cross-contamination. Traditional tissue micro-sampling strategies such as punch- or needle-biopsy do not meet these important requirements. Our initial attempts to obtain numerous spatial specimens from a tissue slice using needle biopsy for spatial tissue sampling showed that the process is very time-consuming and labor-intensive; more importantly, sequential needle sampling across different locations severely distorted the spatial information. To overcome these issues, we designed an arrays-style spatial micro-sampling device, referred to as a micro-scaffold, which contains precisely spaced micro-wells (shown in FIG. 2a and FIG. 22a). The device acquires spatially resolved micro-specimens with a one-strike cutting (i.e., compartmentalization) without distorting the spatial information, and each of the micro-specimens was evenly separated and sequestered inside the micro-wells of the device. In the example shown in FIG. 2a, the micro-scaffold contains 30×30 micro-wells, each with a cross-sectional dimension of 400 μm×400 μm.

To minimize shift/distortion of the tissue slice during the compartmentalization process, each micro-well was designed with tapered edges. The narrower edges effectively and evenly immobilize the tissue slice upon the initial contact and further prevent horizontal motion of the tissue regions during the compartmentalization process, which precisely preserves spatial information (shown in the zoomed panel of FIG. 2a and FIG. 22a). To fabricate the micro-scaffolds, we chose 3D printing for its flexibility in model design and quick turnover in testing and optimization. A number of state-of-the-art JD-printing technologies were carefully evaluated. In this study, the ideal JD-printing technique should carry an ultra-high printing resolution that is necessary to precisely construct the numerous micro-wells in the device, as well as a smooth inner surface to permit the complete and reproducible transfer of micro-specimens out of the wells after compartmentalization. Moreover, the fabricated device should carry excellent uniformity in all directions and the JD-printing technique should be easily implemented in-house, enabling rapid production, testing, and optimization of designs. Several categories of 3D printing techniques were assessed, including fused deposition modeling (FDM), powder bed fusion (such as Selective Laser Sintering (SLS), Selective Laser Melting (SLM)), and photopolymerization (such as Stereolithography (SLA), Digital Light Processing (DLP)). Our initial tests found strategies such as FDM and SLS did not yield sufficient resolution or robustness for the fabrication of micro-scaffolds. By comparison, the photopolymerization-based techniques, which employ ultraviolet (UV) light to solidify the liquid photocurable polymer, afford the highest printing resolution with excellent precision. SLA and DLP are the two most popular types of techniques in this category, and examples include Low Force Stereolithography (LFS), Advanced-OLP, and Projection Micro Stereolithography (PμSL). After careful evaluation of these techniques, we selected the Advanced-OLP on desktop 3D printer (D4Kpro, EnvisionTEC, Germany), owing to its ultra-high printing resolution (~25 μmat the X and Y axes, and 1 μmat Z-axis), high printing speed and reasonable cost. As to the photopolymer, we chose HTM140v2, which is capable of high-resolution printing and meanwhile affords excellent strength for compartmentalization. The combination of the ultra-high resolution Advanced-OLP and the optimal photopolymer enabled the printing of the micro-scaffold with exceptional accuracy and precision (FIG. 2a and FIG. 22a), as well as a smooth inner surface, thus laying a solid foundation for precise, robust spatial micro-compartmentalization of tissue slices.

### The Optimization of the Supporting Matrix for Robust and Complete Tissue Compartmentalization

In our pilot study, we found that to achieve complete separation of individual tissue micro-specimens, it is important to push the micro-scaffold downward till it cuts beyond the tissue layer into a supporting matrix. An ideal supporting matrix should have sufficient elasticity so that under pressurization it can protrude into the micro-wells to facilitate effective shearing of tissue against the narrow edges, and then achieving separation of individual tissue micro-specimens (FIG. 23). The material should be strong enough to sustain the pressure and meanwhile be rupture resistant, so that it can be intactly retracted from the micro-scaffold after the compartmentalization, without leaving pieces inside the micro-wells. Moreover, the material should not contain proteins (i.e., causing contamination of the tissue proteome) or extractable polymers that can't be removed by the μ-SEPOD (discussed later) approach which could be detrimental to LC-MS analysis. Here we evaluated several candidate materials, including starch-based (e.g., Play-Doh), PVC-based (e.g., polymer clay), and silicon-based (e.g., Polydimethylsiloxane-PDMS) modeling materials. Based on the results, we selected the PDMS because of its excellent strength and meanwhile optimal elasticity, and that no contamination proteins or detrimental polymers were introduced to the micro-specimens.

### The Development of a Pressurization Module for Reproducible and Uniform Compartmentalization and Micro-Sampling

As discussed previously, a uniform and well-controlled pressurization across the entire tissue slice is an important prerequisite for robust and reproducible compartmentalization. To achieve this, we designed, fabricated, and optimized a 3D-printed pressurization-control module (FIG. 2b and FIG. 22 b-c), which includes a top and a bottom part that together encloses the stack of micro-scaffold, a tissue slice, and the supporting matrix (upper-to-lower order). The regulated pressure is applied on the top part of the module, which transduces the pressure evenly to the micro-scaffold, facilitating uniform compartmentalization. The design of the module was carefully optimized to ensure precise fitting, alignment, and leveling of components. The detailed parameters and photos of the products are shown in FIG. 22 b-c.

### Optimization of the Micro-Compartmentalization Procedure

In our pilot experiments, we observed that pre-freeze the tissue slice prior to the procedure is important to achieve reproducible compartmentalization. When pressing the micro-scaffold against a fresh brain tissue slice, the resulting micro-specimens are often of varied sizes, likely because of the variable stiffness and density among different anatomical regions. To address this issue, we froze the tissue slice (−80° C., ~30 min) immediately after slicing, which was found to have yielded micro-specimens with uniform sizes and high reproducibility. Compared to fresh tissue slices, pre-freezing the slice achieved much-improved reproducibility, robustness, and uniformity in the size of micro-specimens, as well as more identifiable proteins (FIG. 24).

As to the compartmentalization procedure, the pressure and time for the two steps were optimized to maximize precision, reproducibility, and robustness, and the final conditions are shown in Methods. As shown in FIG. 2d, under the optimized conditions, the entire tissue slice was uniformly and completely compartmentalized without any left-over tissue while the spatial information was faithfully maintained.

Efficient and Reproducible Recovery of Micro-Specimens with 3D-Printed Piston Arrays Under a Well-Regulated Environment Inside a Procurement Chamber

The next critical step following compartmentalization is an efficient and reproducible collection of micro-specimens from the micro-wells. Pilot studies showed that this step must be performed right after micro-compartmentalization and be finished within a short time period (e.g., <4 h), as the prolonged incubation of the specimens inside the micro-scaffold not only caused significant tissue dehydration which renders difficulty in recovering the micro-specimens, but also may result in protein degradation. To enable the efficient, high throughput transfer of micro-specimens out of the scaffold, we devised a series of 3D-printed piston arrays (a total of 16) with breakable pistons to rapidly procure the tissue samples (FIG. 25a). On each array, the pistons match one out of every four micro-wells in both horizontal and vertical directions. As shown in FIG. 25a, the positions of the pistons are strategically staggered among the 16 arrays to cover all the micro-wells. All pistons were scored at 3.95 mm above the base to render them breakable, so that the upper part of the pistons carrying tissue specimens can be readily clipped off with a pair of lab forceps, which were then transferred into low-protein-binding tubes for subsequent sample preparation. With the piston arrays, we can rapidly collect >200 micro-specimens within 1 hour (FIG. 25b). The tissues on the pistons were efficiently extracted using μ-SEPOD (discussed below), and after centrifugation, the pistons were discarded along with the insoluble cellular components.

Furthermore, the above step must be performed under well-regulated conditions, including high humidity (~70-80%) to slow down tissue dehydration, low temperature (−5 to 0° C.) to minimize protein degradation, and free of oxygen to eliminate protein oxidation. To maintain these conditions, we devised a tissue procurement chamber (FIG. 26) equipped with all-angle LED lights to allow shadow-free operation, a controlled humidifier to provide the desired high humidity, and a dry ice container to provide low temperature and saturated CO2 in the chamber. Compared to operation in the open air, procurement of micro-specimens in the chamber improved the success rate (i.e., fully recovered specimens) from 50-60% to 100%.

### Efficient/Reproducible Sample Preparation and LC-MS Analysis, Robustly Across all Micro-Specimens, Another Important Prerequisite for Reliable, Quantitative Mapping of Tissue Proteins

After compartmentalization, numerous micro-specimens were recovered. To realize reliable and accurate mapping of proteins, it is critical to achieve reproducible sample preparation (i.e., protein extraction, sample cleanup, and digestion) with high and consistent efficiency across the many tiny micro-specimens (~100 μg tissue), as well as a sensitive and in-depth LC-MS analysis robustly across this large cohort of samples. To address this daunting challenge, we optimized a μ-SEPOD method that provides efficient and reproducible sample preparation of large sample cohorts with high, quantitative recovery of the micro-size samples. We have also adopted a trapping-nano-LC-MS system that extensively and robustly separates peptides and acquires high-quality, ultra-high-resolution-MS 1 signals with excellent sensitivity consistently across large biological sample sets for reliable analysis of the large cohort of the micro-specimens.

### The Optimization of Microscale Surfactant Cocktail-Aided Extraction/Precipitation/On-Pellet Digestion (μ-SEPOD) for Reproducible and Robust Sample Preparation Across the Large Cohort of Micro-Specimens

Previously we described a surfactant cocktail-aided extraction/precipitation/on-pellet digestion (SEPOD) method for the preparation of large sample cohorts with high efficacy, consistency, and reproducibility. Briefly, the proteins were exhaustively extracted from the tissue by an optimized combination of a strong surfactant cocktail, and then a precipitation step was employed to remove non-protein matrix components and surfactants, which are detrimental to digestion and/or LC-MS analysis. The protein pellet was then digested with high efficiency and finally resulted in a clean sample for LC-MS analysis. The core of this approach is the utilization of a high-concentration cocktail of surfactants, which provided three salient benefits, including near-complete protein recovery from tissues, extensive cleanup of the samples by removing matrix components with the surfactants, and rapid and highly efficient digestion owing to the “dual denaturation” by both the surfactants and precipitation. Compared to other popular methods, the SEPOD provided markedly higher and more reproducible recoveries of proteins and peptides from tissues, especially the membrane proteins.

In this study, we adapted the SEPOD approach to prepare the micro-size tissues with high and consistent efficiency across the large cohort of spatial micro-specimens. Several key parameters were rigorously optimized. Firstly, we assessed the use of 20, 30, and 50 μL surfactant cocktail buffer per sample, in terms of the extraction efficiency, reproducibility, and the number of quantifiable proteins. While using very low volumes of buffer caused incomplete extraction and significant variation, the use of volumes that is too large (i.e., >50 μL for 10 μg protein) would result in low protein concentrations (i.e., <0.2 mg/mL) which compromises the efficiency of SEPOD. In our evaluations, it was observed that using 30 μL buffer (~1:300 tissue: buffer, w/v) resulted in the highest number of quantifiable proteins with excellent extraction efficiency and reproducibility (FIG. 27a), and therefore this volume was selected. Secondly, to achieve a high and reproducible protein recovery, it is critical to thoroughly disrupt the cellular compartments to ensure a thorough protein recovery. Considering the tiny sizes of the micro-specimens, sonication is the only viable choice. Here we compared two sonication approaches: sonication via water bath for 15 min or using a high-power probe sonication for 5 s per cycle, three cycles per sample, as established previously. It was found sonication markedly improved protein extraction efficiency. Though there was no significant difference in protein yields between the two sonication strategies (FIG. 27b), we selected water bath sonication because of the better reproducibility, as well as the easier operation with higher throughput. Moreover, the sonication step also effectively sheared large-molecule-weight nuclear acids into small fragments, which are then removed by the precipitation step.

Finally, protein loss owing to adsorption to the sample tubes is an important concern for the preparation of micro-size tissue samples, which must be evaluated. We found no perceivable protein loss during the extract step since the strong surfactant cocktail buffer prevented protein adsorption. Nonetheless, a substantial loss of peptides was observed during the surfactant-free digestion procedure when using a standard Eppendorf tube. We further discovered that the use of low-protein-binding tubes greatly alleviated this problem, which resulted in higher peptide recovery and more quantified proteins, as shown in FIG. 27c.

Based on the above optimization results, an optimal μ-SEPOD protocol was developed, and the details are shown in Methods.

A Sensitive and Reproducible Trapping Nano-LC High-Resolution MS System for High Quantitative Quality when Analyzing Large Cohort Samples

The other key component to assure the quantitative accuracy of MASP is a protocol for highly sensitive liquid chromatography-mass spectrometry (LC-MS) analysis, with excellent robustness and reproducibility across the large cohort of micro-specimens. Towards this end, we adopted a trapping nano-LC setup that consists of two synchronized LC systems: one micro-flow system utilizing a large inner diameter (I.D.) trapping column, and a nano-flow system using a 65 cm-long analytical column packed with small particles, which have achieved high-resolution chromatographic separation with excellent analytical reproducibility among a large number of samples, as shown in the previous publications. The large-I.D. trapping column is an important component in this system, as it enables highly robust, reproducible, and sensitive analysis of large cohorts. Specifically, i) selective trapping/delivery via the trapping column prevented hydrophilic/hydrophobic matrix components from entering the LC-MS, affording excellent robustness for analysis of many samples; ii) the large-1.D. trapping column provided homogeneously mixed mobile phase to the nano-column, providing highly reproducible separation; iii) the large-1.D. trapping column drastically increased the quantitative loading capacity of the system, and thereby substantially improved the signal-to-noise ratio (SIN) for low-abundance peptides that often represent proteins with critical biological functions.

Ultra-high-resolution (120K-240K FWHM@m/z=200) MSl (UHR-MSl) detection was employed to attain highly selective and sensitive quantification by IonStar, as demonstrated previously. For MS2 fragmentation, HCD/OT rather than HCD/IT mode was employed owing to its low false-positives, which is tremendously beneficial for large-cohort analysis.

This unique LC-MS strategy has enabled sensitive, comprehensive and reliable quantification of the many spatially resolved micro-specimens that were procured in this project. Moreover, we observed exceptional reproducibility and robustness across the analysis of all the micro-specimens, which have laid another solid foundation for reliable quantitative mapping by MASP.

Generation of Protein Distribution Maps Based on the Accurate Protein Quantification by UHR-IonStar and the Development of an R-Based Spatial Mapping App, MAsP, with a Graphical User Interface (GUI)

### Sensitive and Accurate Quantification of the Proteins Among the Micro-Specimens by the UHR-IonStar Data Processing Pipeline

To achieve high-quality quantitative mapping, another important prerequisite is a data processing pipeline capable of sensitive, accurate and reproducible quantification of the many micro-specimens. Furthermore, a large-cohort analysis is often susceptible to problems such as high missing data and elevated false-positives. Towards this end, the UHR-IonStar data processing approach, which achieves exceptional sensitivity and data quality for proteomics quantification in large cohorts, was employed. UHR-IonStar measures peptide MSl precursor ions with ultra-high-resolution (UHR, 240K FWHM@m/z=200), and then uses a novel approach that is to precisely extract UHR-MSl signals from the typically noisy backgrounds with extremely narrow, dynamically-defined ml z windows (e.g., 5 ppm) without losing signal intensity. This strategy effectively improved the selectivity and sensitivity for the quantification of low-abundance proteins. In addition, by employing an efficient chromatogram alignment approach, and a stringent post-feature quality control method, UHR-IonStar showed accurate, precise quantification of large cohorts with low missing data and low false-positives. In this study, the UHR-IonStar method achieved high quantitative precision (median intra-group CV % for protein abundance values among QC replicates was 9.4%) and excellent reproducibility (Pearson correlation r=0.964-0.983 among sample preparation replicates), as shown in FIG. 3a-b and FIG. 30.

Additionally, 5019 proteins were quantified, among which 98.2% (4929 proteins) were quantified in at least 95% of all spatial samples, 91.2% (4577 proteins) were quantified in all regions of the brain slice; indicating the excellent capacity of UHR-IonStar for reproducible measurement in large cohorts.

### The Development of a MAsP App for the Generation and Processing of Protein Distribution Maps

To facilitate rapid and versatile generation and analysis of protein distribution maps in tissues, we developed an R Shiny-based MAsP app (v1.0, https://github.com/JunQu-Lab/MAsP) (FIG. 28). The basic function of this graphical user interface (GUI) app is to generate customizable protein distribution maps based on the spatial coordinates and the protein abundance or the z-score in each micro-specimen. The maps can be generated for either specific proteins or all proteins in the dataset. Parameters such as map resolution, colors, range of abundance/z-score values, and background transparency, can be customized by the users.

Furthermore, the MAsP app can discover protein distribution patterns among the thousands of protein distribution maps generated. To identify proteins with non-random, region-specific distribution patterns, the MAsP app utilizes a published approach that evaluates abundance distribution on maps using the parameter of the percentage of variance explained (VE) in the first singular value after factorization by a singular value decomposition (SVD) made foreach protein distribution map. For example, if values of abundance or z-scores across the whole tissue were randomly distributed, the VE by the first singular value would be very low. An SVD filtering with the user-defined cutoff of the VE threshold can be used to remove protein maps with random regional distribution patterns. Furthermore, the remaining maps with similar regional distribution patterns can be grouped by a spectral clustering algorithm, which is a density-based clustering algorithm designed for image processing.

Finally, proteins with correlated distribution patterns could imply co-localization of these proteins, which may provide highly valuable information on spatially organized biological processes. Here we devised a module to identify protein maps that have correlated distribution patterns with that of a protein of interest, among all MASP-generated maps in the dataset, based on either Pearson correlation coefficient or cosine similarity. A detailed manual about the MAsP app can be found at: https://github.com/JunQu-Lab/mAsP

### The MASP Strategy was Validated and Showed High Accuracy in Quantitative Mapping

We validated the accuracy of protein mapping by MASP in three different ways.

First, low, strategically varied levels of non-endogenous peptides were spiked into the micro-specimens of different locations so that a designed pattern (FIG. 3c, theoretical pattern) would show up in the maps of these peptides if MASP achieved accurate mapping. In brief, we spiked three non-endogenous peptides (GPSVFPLAPSSK, LLINVGSR and LLIIGASTR) at five different levels (0.5-, 0.7-, 1-, 1.3- and 2-fold at low fmol levels, respectively) into the micro-specimens at the designated locations (FIG. 31). These levels were designed to examine the ability of MASP to identify relatively subtle differences in protein abundances among locations. The sequences of the peptides were concatenated into an artificial protein entry, which was then integrated into the mouse proteome database, and quantified along with other proteins in the database. Based on the quantified abundance values, a distribution map of these peptides was constructed and compared with the theoretical distribution map calculated based on the spiked-in ratios across the locations (FIG. 3c, MASP quantified pattern). The result showed that MASP faithfully produced the expected patterns with excellent accuracy (mean error %=12.9%).

Second, we further compared MASP-generated maps of certain proteins against their previously known distribution patterns, such as some literature-reported cell type markers and region-enriched markers. For example, the whole brain distribution of a well-known marker for oligodendrocytes, myelin basic protein (Mbp), has been well-documented. Here we found highly correlated patterns between the MASP-generated map of Mbp and its previously-reported distributions. We further compared the distribution of Mbp with four other oligodendrocytes markers: myelin oligodendrocyte glycoprotein (Mag), oligodendrocyte-specific protein (Osp), and 2′,3′-cyclic-nucleotide 3′-phosphodiesterase (Cnp), and myelin proteolipid protein (Pip). As shown in FIG. 3d, the MASP-generated maps of these markers showed high similarity with the map of Mbp (Pearson r values of 0.95, 0.78, 0.99, and 0.97, respectively), suggesting reliable mapping by MASP. In addition, we also surveyed the maps of some protein markers that are known to be enriched in various brain anatomic regions. MASP correctly recapitulated the expected protein distributions in these anatomical regions such as the cortex (Cacng3, Slc30a3, Synpo) and hypothalamus (Ahi1, Baiap3, Scg2). with high correlations (r=0.81-0.95, FIG. 3d). More examples of regionally enriched proteins are shown in FIG. 32, which include hippocampus-enriched proteins (e.g., Acdy9), cortex-enriched proteins (e.g., Anskl b), striatum-enriched proteins (e.g., Pppl rl b), as well as hypothalamus-enriched proteins (e.g., Scg5), where the MASP-generated protein distribution maps showed patterns consistent with literature.

Third, we tested the quantitative accuracy of MASP by correlating the spatial distributions of the two distinct proteins that form the same heterodimeric protein complex. In this study, only heterodimeric protein complexes that meet the following two criteria were chosen to validate the MASP technique: i) the two proteins in the heterodimer must have distinct, non-overlapping sequences, otherwise the impact of shared peptides might cause overestimation of mapping accuracy; and ii) the majority of the two proteins should exist in the heterodimer form so that these two proteins are co-located. Here, two such heterodimers are evaluated: Tubulin a-heterodimer and Na,K-ATPase a-heterodimer. If the MASP method could accurately recapitulate the spatial distribution of proteins, the maps of the two components of a heterodimer that are independently acquired by MASP, should show highly similar distribution patterns. Indeed, highly correlated patterns of the two components were observed for the two above-mentioned heterodimers (r=0.93, and 0.95, respectively, FIG. 3e), which validates the accuracy of mapping by MASP.

Although the present disclosure has been described with respect to one or more particular embodiments, it will be understood that other embodiments of the present disclosure may be made without departing from the spirit and scope of the present disclosure.

What is claimed is:

1. A tissue sample sectioning device comprising:
a supporting matrix having a top surface configured to accept a tissue sample thereon;
a micro-scaffold comprising a top, a bottom, and a plurality of micro-wells, wherein each micro-well is defined by one or more walls that extend between the top and the bottom of the micro-scaffold, and each of the one or more walls defines a cutting edge at the bottom of the micro-scaffold; and
a press configured to apply a force at the top of the micro-scaffold, such that when the force is applied, the cutting edge is pressed into the supporting matrix, thereby cutting a tissue sample into a plurality of micro-sections, each micro-section remaining in a micro-well of the plurality of micro-wells.

2. The tissue sample sectioning device of claim 1, further comprising an ejector configured to remove each micro-section of the tissue sample from the respective micro-well of the plurality of micro-wells.

3. The tissue sample sectioning device of claim 1, wherein the press is configured to apply a first force to the micro-scaffold, followed by a second force which is greater than the first force.

4. The tissue sample sectioning device of claim 3, further comprising a pressure sensor configured to measure a force applied by the press.

5. The tissue sample sectioning device of claim 1, wherein the press further comprises a top portion and a bottom portion, wherein the top portion comprises at least one aperture and the bottom portion comprises at least one protrusion, wherein the at least one protrusion is configured to fit into the at least one aperture.

6. The tissue sample sectioning device of claim 1, further comprising a chamber configured to house the supporting matrix, the micro-scaffold, and the press.

7. The tissue sample sectioning device of claim 6, wherein the chamber is configured to regulate a temperature of the supporting matrix and a temperature of the micro-scaffold.

8. The tissue sample sectioning device of claim 7, wherein the chamber further comprises a light, a dry ice container, etc., at least one fan, at least one humidifier, at least one temperature sensor, and/or at least one humidity sensor.

9. The tissue sample sectioning device of claim 6, wherein the chamber is made from a clear material.

10. The tissue sample sectioning device of claim 1, wherein the micro-scaffold has a length of between 1-15 cm, inclusive, and a width of between 1-15 cm.

11. The tissue sample sectioning device of claim 1, wherein the micro-scaffold is a resin material.

12. The tissue sample sectioning device of claim 11, wherein the micro-scaffold is made of HTM 140 V2 resin.

13. The tissue sample sectioning device of claim 1, wherein the micro-scaffold is a metal material.

14. The tissue sample sectioning device of claim 1, wherein the micro-scaffold comprises between 50-40,000 micro-wells, inclusive.

15. The tissue sample sectioning device of claim 1, wherein each micro-well of the plurality of micro-wells has a length of between 50 μm and 1000 μm, inclusive, and a width of between 50 μm and 1,000 μm, inclusive.

16. The tissue sample sectioning device of claim 1, wherein each of the one or more walls of the plurality of micro-wells has a thickness of between 5 μm and 200 μm, inclusive.

17. The tissue sample sectioning device of claim 1, wherein each micro-well of the plurality of micro-wells have a quadrilateral cross-sectional shape.

18. The tissue sample sectioning device of claim 17, wherein the micro-scaffold includes an array of 30×30 micro-wells.

19. The tissue sample sectioning device of claim 18, wherein each micro-well of the plurality of micro-wells has a length of between 50 μm and 400 μm, inclusive, and a width of between 50 μm and 400 μm, inclusive.

20. The tissue sample sectioning device of claim 1, wherein each micro-well of the plurality of micro-wells has a hexagonal cross-sectional shape.

21. The tissue sample sectioning device of claim 1, wherein the supporting matrix is made of Polydimethylsiloxane (PDMS).

22. The tissue sample sectioning device of claim 1, wherein the supporting matrix has a quadrilateral shape.

23. The tissue sample sectioning device of claim 22, wherein the dimensions of the supporting matrix are 13 cm×13 cm×1 cm.

24. The tissue sample sectioning device of claim 1, wherein the supporting matrix has a thickness of 5 mm.

25. A method of sectioning a tissue sample comprising:
placing a tissue sample onto a supporting matrix;
placing a cutting edge of a micro-scaffold onto the tissue sample, wherein the micro-scaffold comprises a plurality of micro-wells;
applying a force to the micro-scaffold, wherein the cutting edge of the micro-scaffold cuts the tissue sample into a plurality of micro-sections, and each micro-section of the plurality of micro-sections is disposed in a corresponding micro-well of the plurality of micro-wells; and
collecting the plurality of micro-sections from the plurality of micro-wells.

26. The method of claim 25, further comprising transferring the plurality of micro-sections into sample tubes.

27. The method of claim 26, wherein collecting the micro-sections from the plurality of micro-wells further comprises inserting a piston array into the plurality of micro-wells, wherein each piston of the piston array is arranged to penetrate a corresponding micro-well of the plurality of micro-wells to collect the micro-section disposed therein.

28. The method of claim 27, wherein each piston of the piston array is scored at least 1 mm from a tip end to form a breakable tip.

29. The method of claim 27, wherein each piston of the piston array is scored at 3.95 mm from a tip end.

30. The method of claim 28, wherein the breakable tip of the at least one piston is arranged to penetrate the micro-section.

31. The method of claim 30, further comprising separating the breakable tip of each piston of the piston array from the piston; and placing each separated breakable tip into a corresponding sample tube.

32. The method of claim 26, wherein collecting the micro-sections from the plurality of micro-wells further comprises pushing the micro-sections using a fused silica tube.

33. The method of claim 32, wherein the fused silica tube has an outer diameter of 180 μm-500 μm.

34. The method of claim 26, wherein collecting the micro-sections from the plurality of micro-wells further comprises cutting the micro-sections with a laser.

35. The method of claim 26, wherein the collecting the micro-sections from the plurality of micro-wells further comprises pushing the micro-sections with an end-effector of a robotic arm.

36. The method of claim 26, wherein collecting the micro-sections from the plurality of micro-wells further comprises liquefying each micro-section and pipetting each liquified micro-section from the micro-wells.

37. The method of claim 25, wherein the tissue sample has a thickness of between 1-2 mm, inclusive.

38. The method of claim 25, wherein the force is generated with a press.

39. The method of claim 25, wherein applying a force to the micro-scaffold comprises:
applying a first force to the micro-scaffold;
applying a second force to the micro-scaffold; and
wherein the second force has a magnitude which is greater than a magnitude of the first force.

40. The method of claim 39, wherein the first force has a magnitude of between 3-5 kg, inclusive.

41. The method of claim 39, wherein the second force has a magnitude of between 10-15 kg, inclusive.

42. The method of claim 25, wherein the supporting matrix has a temperature of between 0° C.-10° C., inclusive.

43. The method of claim 25, wherein the tissue sample has a temperature of between −10° C.-−5° C., inclusive.

44. The method of claim 25, wherein the micro-scaffold has a temperature of between 0° C.-10° C., inclusive.

45. The method of claim 25, wherein the cutting edge of the micro-scaffold cuts into the tissue sample at 0° C.-10° C.

46. The method of claim 25, wherein the plurality of micro-sections are collected from the micro-wells at 0° C.-10° C.
